(19) United States
(12) Patent Application Publication
(10) Pub. No.: US 2025/0289720 A1
(43) Pub. Date: Sep. 18, 2025

(54) GRAPHENE-METAL ELECTRODES, AND METHODS OF PRODUCING THE SAME

(71) Applicant: NanoXplore Inc., Montreal (CA)

(72) Inventors: Nima MOGHIMIAN, Saint Laurent (CA); Garion HICKS, Montreal (CA); Tatiana KAYDANOVA, Montreal (CA); Soroush NAZARPOUR, Saint-Laurent (CA)

(21) Appl. No.: 19/077,455

(22) Filed: Mar. 12, 2025

Related U.S. Application Data
(60) Provisional application No. 63/564,672, filed on Mar. 13, 2024.

(51) Int. Cl. C01B 32/21

(52) U.S. Cl. CPC C01B 32/21; C01P 2002/72; C01P 2002/85; C01P 2004/03; C01P 2004/51; C01P 2004/61; C01P 2004/62; C01P 2006/12; C01P 2006/40

(57) ABSTRACT

Embodiments described herein relate to methods of producing electrodes. In some aspects, a method can include mixing a plurality of layered particles with a plurality of non-layered particles. The method further includes milling the plurality of layered particles and the plurality of non-layered particles in a controlled environment to form a composite. The method further includes forming the composite into an electrode. In some embodiments, the controlled environment has a pressure of no more than about 0.3 bar absolute. In some embodiments, the controlled environment can include at least about 99.9 vol % of an inert gas. In some embodiments, the plurality of layered particles can include graphite particles. In some embodiments, the plurality of non-layered particles can include silicon particles.

### CROSS-REFERENCE TO RELATED APPLICATIONS

This application claims priority to and the benefit of U.S. Provisional Patent Application No. 63/564,672, filed Mar. 13, 2024, titled, “Graphene-Metal Electrodes, and Methods of Producing the Same,” the disclosure of which is hereby incorporated by reference in its entirety.

### TECHNICAL FIELD

Embodiments described herein relate to production of electrode active materials under controlled environments.

### BACKGROUND

Silicon (Si) has been considered promising for large-scale energy storage applications due to its higher theoretical capacity than current commercial graphite anodes. However, Si is often plagued by issues such as high volume expansion, poor electrical conductivity, and slow kinetics of charge transfer and ion diffusion during electrochemical reactions.

To address the low conductivity of Si, various studies report introducing conductive coating layers on the Si surface, which can effectively increase the conductivity of Si and improve overall electrochemical performance. Graphene, a product of graphite exfoliation, is a promising potential candidate to be combined with Si due to its superior mechanical, thermal, and electrical properties. As such, silicon-graphene composites, can leverage the respective strengths of silicon and graphene. Despite the development of numerous fabrication methods for silicon-graphene composites, including ball-milling, sol-gel method, and chemical vapor deposition (CVD), challenges persist in their production and use. These challenges, which include the complexity of technology, production capacity, poor cycle life performance, and manufacturing costs, remain significant obstacles to industrialization.

### SUMMARY

Embodiments described herein relate to methods of producing electrodes. In some aspects, a method can include mixing a plurality of layered particles with a plurality of non-layered particles. The method further includes milling the plurality of layered particles and the plurality of non-layered particles in a controlled environment to form a composite. The method further includes forming the mixture into an electrode (e.g., an anode). In some embodiments, the controlled environment has a pressure of no more than about 0.3 bar absolute. In some embodiments, the controlled environment can include at least about 99.9 vol % of an inert gas. In some embodiments, the controlled environment can be held at a pressure of no more than about 0.1 bar absolute. In some embodiments, the plurality of layered particles can include graphite particles. In some embodiments, the plurality of non-layered particles can include silicon particles. In some embodiments, the mixing and milling can occur at least partially simultaneously. In some embodiments, the mixing can include mixing an additive (e.g., a conductive additive) with the plurality of layered particles and the plurality of non-layered particles.

### BRIEF DESCRIPTION OF THE DRAWINGS

FIG. 1 is a flow diagram of a method of producing a composite electrode material, according to an embodiment.

FIG. 2 is a block diagram of a milling vessel, according to an embodiment.

FIG. 3 is an illustration of a milling vessel, according to an embodiment.

FIG. 4 is a graphic representation of a specific capacity retention comparison between electrodes produced in a controlled environment vs. electrodes produced in an uncontrolled environment.

FIGS. 5A-5D show scanning electron microscopy (SEM) images illustrating the material transformations at various processing stages of method 10. FIG. 5A is a SEM image of a feed material prior to pre-milling. FIG. 5B is a SEM image of the feed material after pre-milling. FIG. 5C is a SEM image of the composite after milling. FIG. 5D is a SEM image of the composite coated with a carbon coating.

FIG. 6 shows X-ray diffraction (XRD) results of composites obtained by method 10 under different conditions.

FIG. 7 shows X-ray photoelectron spectroscopy (XPS) results of composites obtained by method 10 under different conditions.

### DETAILED DESCRIPTION

Embodiments described herein relate to manufacturing of composites and the use thereof as electrode active materials for batteries. The composites described herein are particularly advantageous when used in anodes. Embodiments described herein include methods of milling layered particles (e.g., graphene) with non-layered particles (e.g., metal or metal oxide particles) under controlled environment to form a composite that is beneficial as active materials for secondary batteries and other electrical applications. In some embodiments, the milling can be conducted under vacuum conditions. In some embodiments, the milling can be performed in an inert atmosphere. Dry milling conducted in a controlled environment, such as under reduced pressure, can lead to enhanced binding interactions between the composite-forming particles, such as graphene and Si particles. This results in a more efficient compositing process, yielding composites that exhibit increased durability during the charge and discharge cycles of battery operation. Thus, degradation of the battery during cycling is mitigated and cycle lifetime is improved.

Silicon is one of the most promising candidates to replace current commercial graphite anodes (theoretical capacity ˜372 mAh g⁻¹) due to its much higher theoretical capacity (4,200 mAh g⁻¹), low intercalation/deintercalation lithium potential, and abundant sources. However, the large volume-expansion (>300%) during cycling leads to substantial cracking of the Si particles and pulverization at the anode. Therefore, battery anodes with silicon often have lower specific capacities than would otherwise be predicted. Silicon also has poor electrical conduction.

As the exfoliation product of graphite, graphene, a two-dimensional monolayer carbon material with a sp² hybridization, is a much better conductor than silicon, particularly under vacuum conditions. Coating graphene onto the surface of silicon during the compositing process can increase the electrical accessibility of the silicon particles during the cycling process. Therefore, the specific capacity of the anode increases. This improves the economics, efficiency, environmental impact, and adaptability of production methods for manufacturing high-performance graphene-based composite anode materials for energy applications.

Although silicon-graphene composites have numerous advantages compared to their single components, silicon-graphene composites are not yet used as anodes for commercially available lithium-ion batteries due to challenges associated with their current production and use. Although several fabrication approaches have been developed to obtain silicon-graphene hybrids (e.g., ball-milling, sol-gel method, and CVD), obstacles in industrialization still cannot be overcome in terms of the complexity of technology, production capacity, and manufacturing costs.

Ball milling, on the other hand, is a very promising approach to prepare silicon-graphene composites due its cost-effectiveness and suitability for large-scale manufacturing. Graphite includes multiple layers of carbon arranged in well-structured sheets. When these sheets are individually extracted from the graphite superstructure, they are collectively referred to as graphene. Combining graphene with high-capacity materials such as silicon can be advantageous for imparting electrical conductivity and providing stability during charge and/or discharge cycling. Graphene can be simultaneously generated and combined with silicon particles via processes such as ball milling. This characteristic makes graphene well suited for creating nano-composites or conductive/protective coatings. Silicon or metal oxides can be coated or combined with graphene to form composites having full advantage of the respective strengths of Si/metal oxides and graphene. Conventional milling, however, often leads to a non-uniform distribution and weak adhesion between the Si and graphene due to absence of strong interaction.

In contrast, silicon-graphene composites produced under low-pressure conditions, as described herein, offer several benefits. These include enhanced binding interactions between silicon, graphene, and other additives, leading to more robust composites that improve the battery's cycle life. The high surface area of exfoliated graphene increases the electrical accessibility of silicon particles during the cycling process, thereby increasing the battery anode's specific capacity. Furthermore, the milling and compositing process is simple and scalable, making it a more efficient alternative to slower and more expensive methods. Lastly, the silicon-graphene composite has a more than about 40% higher specific capacity and a significantly longer cycle life compared to the same composition produced without a controlled atmosphere. These collective benefits make the silicon-graphene composites presented herein a promising solution for advanced energy storage applications.

Embodiments described herein include combining layered particles and non-layered particles in a controlled environment. In some embodiments, this environment can include a vacuum or low pressure. In some embodiments, this environment can include an inert atmosphere. Batteries made with electrodes (e.g., anodes) produced from methods described herein have demonstrated significant advantages over regular milling under standard atmospheric conditions in the electrochemical performance of the final product. In some embodiments, the layered particles and the non-layered particles can undergo a dry milling process under a controlled atmosphere.

In some embodiments, the layered particles can include graphite. In some embodiments, the non-layered particles can include silicon. In some embodiments, the non-layered particles can include silica particles. Graphite and silicon can undergo a dry-milling process in a sealed vessel under conditions of low pressure (e.g., no more than 0.3 bar). The dry milling process can simultaneously exfoliate the flake graphite material to produce high surface-area graphene sheets and combine or composite the layered particles with the non-layered particles and any other materials present. The resulting mixed product can be useful as an anode active material in secondary batteries.

The low pressure of a sealed milling vessel also facilitates the exfoliation process, such that the surface area of the graphene increases by a factor of at least about 10. Strong binding interactions in the composite product can result in mechanofusion. The resulting electrode can have a significantly higher capacity than electrodes produced from conventional processes.

Charging and discharging of batteries with silicon can cause significant degradation of battery performance over successive cycles. Compositing anode materials under ambient conditions can produce weaker binding interactions between anode particles, such that few composites are formed and the composites that are formed are incomplete and not robust to charging/discharging during battery cycling.

In some embodiments, graphene particles or flakes described herein can have any of the properties of the graphene flakes described in U.S. Pat. No. 9,469,542 (“the '542 patent”), filed Dec. 22, 2015, and titled, “Large Scale Production of Thinned Graphite, Graphene, and Graphite-Graphene Composites,” the entire disclosure of which is hereby incorporate by reference and attached hereto as Exhibit A.

As used herein, the term “crystalline graphite” or “precursor crystalline graphite” refers to graphite-based material of a crystalline structure with a size configured to allow ball milling in a ball milling jar. For example, the crystalline graphite can be layered graphene sheets with or without defects, such defects comprising vacancies, interstitials, line defects, etc. The crystalline graphite may come in diverse forms, such as but not limited to ordered graphite including natural crystalline graphite, pyrolytic graphite (e.g., highly ordered pyrolytic graphite (HOPG)), graphite fiber, graphite rods, graphite minerals, graphite powder, flake graphite, any graphitic material modified physically and/or chemically to be crystalline, and/or the like. As another example, the crystalline graphite can be graphite oxide.

As used herein, the term “thinned graphite” refers to crystalline graphite that has had its thickness reduced to a thickness from about a single layer of graphene to about 1,200 layers, which is roughly equivalent to about 400 nm. As such, single layer graphene sheets, few-layer graphene (FLG) sheets, and in general multi-layer graphene sheets with a number of layers about equal to or less than 1,200 graphene layers can be referred as thinned graphite.

As used herein, the term “few-layer graphene” (FLG) refers to crystalline graphite that has a thickness from about 1 graphene layer to about 10 graphene layers.

As used herein, the term “lateral size” or “lateral sheet size” relates to the in-plane linear dimension of a crystalline material. For example, the linear dimension can be a radius, diameters, width, length, diagonal, etc., if the in-plane shape of the material can be at least approximated as a regular geometrical object (e.g., circle, square, etc.). If the in-plane shape of the material cannot be modeled by regular geometrical objects relatively accurately, the linear dimension can be expressed by characteristic parameters as is known in the art (e.g., by using shape or form factors).

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of batteries, the plurality of batteries can be considered as multiple, distinct batteries or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, “average dimension” refers to an average distance across a 3-dimensional particle. For a spherical particle, an average dimension would refer to the spherical particle's diameter. For an irregularly shaped particle, the average dimension would refer to the average distance across the particle across all imaginary lines running through the center of mass of the particle.

As used herein, the term “D50” refers to the cumulative 50% size on a volume basis (D50), which is the dimension at the point of 50% on the cumulative curve when the cumulative curve is plotted (e.g., the particle diameter at the 50th percentile (median) of the particle volume), such that a particle size distribution is obtained on a volume basis and the total volume is 100%.

As used herein, “particle size” refers to an average distance across a 3-dimensional particle. For a spherical particle, an average dimension would refer to the spherical particle's diameter. For an irregularly shaped particle, the average dimension would refer to the average distance across the particle across all imaginary lines running through the center of mass of the particle.

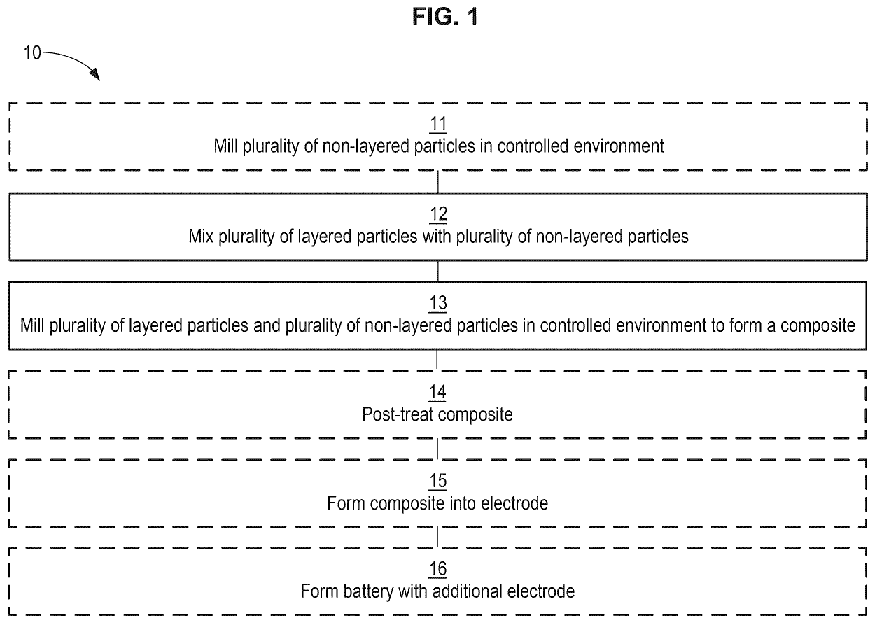

FIG. 1 is a flow diagram of a method 10 of forming a composite, according to an embodiment. The method 10 optionally includes milling a plurality of non-layered particles in a first controlled environment at step 11. The method 10 includes mixing a plurality of layered particles with a plurality of non-layered particles to form a mixture at step 12. The method 10 further includes milling the plurality of layered particles and the plurality of non-layered particles in a second controlled environment to form a composite at step 13. In some embodiments, the mixing and the milling can occur at least partially simultaneously. In some embodiments, the method 10 may include post-treating the composite at step 14. In some embodiments, the method 10 may include forming the composite into an electrode at step 15. At step 16, the method 10 optionally includes forming a battery including the electrode formed at step 15 with an additional electrode.

In some embodiments, the method 10 may further include pre-processing steps (not shown in FIG. 1). In some embodiments, the method 10 can include heating at least one of the plurality of layered particles, or the plurality of non-layered particles prior to step 11, or step 12. In some embodiments, the heating step can remove at least about 80%, at least about 85%, at least about 90%, at least about 95%, or at least about 99% of moisture from at least one of the plurality of layered particles or the plurality of non-layered particles.

In some embodiments, the plurality of layered particles and/or the plurality of non-layered particles can be maintained at an elevated temperature for a warming period to desiccate the plurality of layered particles and/or the plurality of non-layered particles. In some embodiments, the at least one of a plurality of layered particles or a plurality of non-layered particles can be maintained at a temperature of at least about 50° C., at least about 55° C., at least about 60° C., at least about 65° C., at least about 70° C., at least about 75° C., at least about 80° C., at least about 85° C., at least about 90° C., at least about 95° C., at least about 100° C., at least about 105° C., at least about 110° C., at least about 115° C., at least about 120° C., at least about 125° C., at least about 130° C., at least about 135° C., at least about 140° C., at least about 145° C., at least about 150° C., at least about 155° C., at least about 160° C., at least about 165° C., at least about 170° C., at least about 175° C., at least about 180° C., at least about 185° C., at least about 190° C., at least about 195° C., or at least about 200° C. for the warming period. In some embodiments, the at least one of a plurality of layered particles or a plurality of non-layered particles can be kept at a temperature of no more than about 250° C., no more than about 245° C., no more than about 240° C., no more than about 235° C., no more than about 230° C., no more than about 225° C., no more than about 220° C., no more than about 215° C., no more than about 210° C., no more than about 205° C., or no more than about 200° C., for the warming period. Combinations of the above-referenced temperatures are also possible (e.g., at least about 50° C. and no more than about 250° C. or at least about 120° C. and no more than about 180° C.), inclusive of all values and ranges therebetween. In some embodiments, the at least one of a plurality of layered particles, or a plurality of non-layered particles can be kept at a temperature of about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., about 200° C., about 210° C., about 220° C., about 230° C., about 240° C., or about 250° C. for the warming period.

In some embodiments, the warming period can be at least about 10 minutes, at least about 20 minutes, at least about 30 minutes, at least about 40 minutes, at least about 50 minutes, at least about 1 hour, at least about 2 hours, at least about 3 hours, at least about 4 hours, at least about 5 hours, at least about 6 hours, at least about 8 hours, at least about 10 hours, at least about 12 hours, at least about 18 hours, or at least about 24 hours. In some embodiments, the warming period can be no more than about 4 days, no more than about 3 days, no more than about 2 days, no more than about 1 day, no more than about 20 hours, no more than about 18 hours, no more than about 12 hours, or no more than about 10 hours. Combinations of the above-referenced temperatures are also possible (e.g., at least about 10 minutes and no more than about 4 days or at least about 2 hours and no more than about 6 hours), inclusive of all values and ranges therebetween.

In some embodiments, pre-processing steps prior to step 11, or step 12 may include subjecting at least one of the plurality of layered particles or the plurality of non-layered particles to conditions including, but limited to, vacuum, heating or exposure to dry nitrogen to remove at least about 80%, at least about 85%, at least about 90%, at least about 95%, at least about 99%, of moisture from at least one of the plurality of layered particles or the plurality of non-layered particles.

At step 11, the plurality of non-layered particles can undergo a milling process within a first controlled environment, such as a low-pressure atmosphere (e.g., no more than about 0.3 bar absolute) and/or an inert gas environment, in the absence of the plurality of layered particles. In some embodiments, the milling can be conducted under vacuum (e.g., less than ambient pressure). In some embodiments, the milling can be conducted in an inert gas atmosphere (e.g., argon, nitrogen, or combination thereof).

In some embodiments, the milling at step 11 can reduce particle size of the plurality of non-layered particles. Without being bound by theory, reducing the particle size of the plurality of non-layered particles can mitigate negative effects associated with the volume expansion of these particles during charge/discharge cycling when used in an electrode. This reduction in particle size may improve the structural stability of the non-layered particles over extended cycles. In some embodiments, the milling at step 11 can induce formation of an amorphous layer on the surface of the plurality of non-layered particles, which may contribute to an increase in cycle stability. In some embodiments, the milling at step 11 can increase the surface area of the plurality of non-layered particles while simultaneously disrupting any native oxide layer on their surface. This disruption may enhance the mechanofusion of the plurality of non-layered particles with the plurality of layered particles in subsequent processing steps 12, and 13 which can serve to protect the non-layered particles and improve the specific capacity of the composite. Accordingly, the milling in step 11 can improve the stability and/or specific capacity of the resulting composite material obtained by method 10. In some embodiments, the composite material produced from the milled non-layered particles may exhibit enhanced stability and/or specific capacity compared to a composite material derived from non-layered particles that have not undergone the milling process in step 11.

Following the completion of the milling process in step 11, in some embodiments, the non-layered particles (i.e., milled non-layered particles) can be exposed to air, thereby causing partial or complete oxidation of the surface of the non-layered particles. In some embodiments, the exposure to air can occur immediately after the milling step (step 11) or during material transfer prior to the subsequent processing steps (e.g., step 12, and/or step 13). In some embodiments, the oxidation can result in the formation of an oxide layer on the surface of the non-layered particles, which can help stabilize the particles and reduce unwanted side reactions in later processing steps. In some embodiments, the oxide layer can have a thickness of at least about 1 nm, at least about 2 nm, at least about 3 nm, at least about 4 nm, at least about 5 nm, at least about 6 nm, at least about 7 nm, at least about 8 nm, at least about 9 nm, or at least about 10 nm, and no more than about 50 nm, no more than about 45 nm, no more than about 40 nm, no more than about 35 nm, no more than about 30 nm, no more than about 25 nm, no more than about 20 nm, no more than about 15 nm, or no more than about 10 nm. Combinations of these values are also possible, inclusive of all values and ranges therebetween. In some embodiments, the controlled oxidation can be beneficial in modulating the surface chemistry of the milled non-layered particles, thereby enhancing the electrochemical performance of the composite material.

Alternatively, in some embodiments, following the completion of the milling process in step 11, the non-layered particles may be exposed to a gas or gas mixture to functionalize the surface of the non-layered particles and/or introduce dopants into the non-layered particles, thereby ultimately enhancing the electrochemical performance of the non-layered particles or the composite including the non-layered particles when used in a battery cell. Suitable gases or gas mixtures for this purpose include, but are not limited to, ammonia (NH₃), sulfur hexafluoride (SF₆), or nitrogen trifluoride (NF₃), which can improve electrolyte stability and solid electrolyte interphase (SEI) properties. In some embodiments, the exposure to the gas or gas mixture can occur immediately after the milling step (step 11) or during material transfer prior to the subsequent processing steps (e.g., step 12, and/or step 13).

In some embodiments, the milling step 11 can be performed in a vessel/container, and at step 12, the plurality of non-layered particles can be introduced into the same vessel or container. In some embodiments, step 13 can be performed within the same vessel, allowing the processing of both non-layered and layered particles in a continuous or semi-continuous manner. Conducting these steps in the same vessel can provide benefits such as reducing material transfer losses, reducing contamination, and/or improving processing efficiency.

The milling process at step 11 can reduce the D50 particle size of the plurality of non-layered particles by at least about 30%, at least about 35%, at least about 40%, at least about 50%, at least about 60%, at least about 70%, at least about 80%, or even 85% or more, depending on the milling duration, intensity, and selected parameters. Additionally, the milling process can further improve the surface smoothness and/or the sphericity of the non-layered particles, which can enhance their packing density and uniformity. These improvements can lead to better electrochemical performance and stability when the particles are used in battery cells.

In some embodiments, milling can be performed in a high-energy planetary ball mill, an attritor mill, or another suitable milling apparatus capable of exerting sufficient mechanical energy to achieve the desired particle size reduction. The milling media may include zirconia, tungsten carbide, stainless steel, titanium, and/or polymeric balls, with desired ball-to-powder ratios ranging from about 5:1 to about 50:1. Additionally, process parameters such as milling time (e.g., from 30 minutes to 48 hours) and rotational speed (e.g., from 100 rpm to 900 rpm) can be adjusted to control the final particle morphology.

In some embodiments, the milling duration can range from at least about 30 minutes, at least about 1 hour, at least about 2 hours, at least about 3 hours, at least about 4 hours, at least about 5 hours, at least about 6 hours, at least about 8 hours, at least about 10 hours, at least about 12 hours, at least about 16 hours, at least about 18 hours, at least about 20 hours, at least about 24 hours, at least about 30 hours, at least about 36 hours, or at least about 48 hours. In some embodiments, the milling duration may be no more than about 72 hours, no more than about 60 hours, no more than about 48 hours, no more than about 36 hours, no more than about 30 hours, no more than about 24 hours, no more than about 20 hours, no more than about 16 hours, or no more than about 12 hours. Combinations of these values are also possible (e.g., at least about 2 hours and no more than about 48 hours, or at least about 6 hours and no more than about 24 hours), inclusive of all values and ranges therebetween. A desired milling duration can be decided based on a balance between particle refinement and structural integrity, reducing excessive amorphization or aggregation. In some embodiments, the milling is performed for a duration ranging from about 50 minutes to about 200 minutes.

In some embodiments, the milling speed can be at least about 100 rpm, at least about 150 rpm, at least about 200 rpm, at least about 250 rpm, at least about 300 rpm, at least about 350 rpm, at least about 400 rpm, at least about 450 rpm, at least about 500 rpm, at least about 550 rpm, at least about 600 rpm, at least about 650 rpm, at least about 700 rpm, at least about 750 rpm, or at least about 800 rpm. In some embodiments, the milling speed may be no more than about 1000 rpm, no more than about 900 rpm, no more than about 850 rpm, no more than about 800 rpm, no more than about 750 rpm, no more than about 700 rpm, no more than about 650 rpm, no more than about 600 rpm, or no more than about 500 rpm. Combinations of these values are also possible (e.g., at least about 200 rpm and no more than about 800 rpm, or at least about 400 rpm and no more than about 700 rpm), inclusive of all values and ranges therebetween. In some embodiments, the milling speed is about 760 rpm.

In some embodiments, the first controlled environment and the second controlled environment can be similar or substantially the same. In some embodiments, the first controlled environment can be maintained under vacuum, an inert gas atmosphere (e.g., argon, nitrogen), or a low-humidity environment (e.g., 5% moisture, or lower). Implementing controlled environmental conditions, such as an inert atmosphere, vacuum, or low moisture content, during milling at step 11 can enhance the overall electrochemical performance of the composite. For example, these improvements may lead to higher first-cycle Coulombic efficiency, greater specific capacity retention, reduced electrode swelling, and/or enhanced long-term cycling stability.

In some embodiments, the first controlled environment can include a low-humidity environment (e.g., an environment having a moisture level of less than 1%, or in some cases between 0.1% and 0.5%). In some embodiments, the low-humidity environment can prevent excessive adhesion of non-layered particles to the milling media and minimize unwanted reactions, such as oxidation or hydrolysis. In some embodiments, drying steps prior to step 11, such as vacuum drying, cryogenic drying, or thermal treatment, can be implemented to achieve the desired moisture level before milling. In some embodiments, the first controlled environment can have a moisture content of no more than about 5%, no more than about 4%, no more than about 3%, no more than about 2.5%, no more than about 2%, no more than about 1.5%, no more than about 1%, no more than about 0.8%, no more than about 0.5%, or no more than 0.1%. In some embodiments, the first controlled environment has a moisture content of 0.1% or less.

In some embodiments, the plurality of the non-layered particles that undergo step 11 can have a particle size of at least about 1 μm, at least about 1.2 μm, at least about 1.5 μm, at least about 1.8 μm, at least about 2 μm, at least about 2.5 μm, at least about 3 μm, at least about 3.5 μm, at least about 4 μm, at least about 4.5 μm, at least about 5 μm, at least about 5.5 μm, at least about 6 μm, at least about 6.5 μm, at least about 7 μm, at least about 7.5 μm, at least about 8 μm, at least about 8.5 μm, at least about 9 μm, or at least about 9.5 μm. In some embodiments, the non-layered particles that undergo step 11 can have a particle size of no more than about 10 μm, no more than about 9.5 μm, no more than about 9 μm, no more than about 8.5 μm, no more than about 8 μm, no more than about 7.5 μm, no more than about 7 μm, no more than about 6.5 μm, no more than about 6 μm, no more than about 5.5 μm, or no more than about 5 μm. Combinations of these values are also possible (e.g., at least about 1 μm and no more than about 10 μm, or at least about 3 μm and no more than about 7 μm), inclusive of all values and ranges therebetween. In some embodiments, the plurality of the non-layered particles that undergo step 11 can have a particle size of about 1.4 μm. The particle size of the non-layered particles that undergo step 11 can affect the properties (e.g., physical properties) of the resulting milled non-layered particles.

At step 12, mixing a plurality of layered particles with a plurality of a non-layered particles to form a mixture includes mixing the plurality of layered particles with the plurality of non-layered particles for a certain period of time. In some embodiments, the certain period of time is at least about 10 minutes, at least about 20 minutes, at least about 30 minutes, at least about 40 minutes, at least about 50 minutes, at least about 1 hour, at least about 2 hours, at least about 3 hours, at least about 4 hours, at least about 5 hours, at least about 6 hours, at least about 8 hours, at least about 10 hours, at least about 12 hours, at least about 18 hours, or at least about 24 hours.

In some embodiments, the mixing can be via an impeller. In some embodiments, the mixing can be facilitated by an agitator. In some embodiments, the mixing can include vibration-mixing.

In some embodiments, the plurality of layered particles can include at least one of graphite particles, or graphene particles (e.g., FLG graphene).

In some embodiments, the plurality of layered particles can be present in an amount of at least from about 5 wt % to no more than about 35 wt % within the mixture formed at step 12. In some embodiments, the plurality of layered particles can make up at least about 5 wt %, at least about 7 wt %, at least about 9 wt %, at least about 10 wt %, at least about 13 wt %, at least about 15 wt %, at least about 17 wt %, at least about 19 wt %, at least about 20 wt %, at least about 21 wt %, at least about 23 wt %, at least about 25 wt %, at least about 27 wt %, or at least about 30 wt %, of the mixture formed at step 12. In some embodiments, the plurality of layered particles can make up no more than about 35 wt %, no more than about 33 wt %, no more than about 31 wt %, no more than about 30 wt %, no more than about 27 wt %, no more than about 25 wt %, no more than about 23 wt %, no more than about 20 wt %, no more than about 17 wt %, no more than about 15 wt %, no more than about 13 wt %, or no more than about 10 wt %, of the mixture formed at step 12. Combinations of the above-referenced weight percentages are also possible (e.g., at least about 5 wt % and no more than about 35 wt % or at least about 10 wt % and no more than about 25 wt %), inclusive of all values and ranges therebetween.

In some embodiments, the plurality of layered particles can include graphite particles. In some embodiments, graphite particles can include crystalline graphite. The crystalline graphite may have diverse forms. In some embodiments, the crystalline graphite includes at least one of natural graphite, synthetic graphite, highly oriented pyrolytic graphite (HOPG), graphite fiber, graphite rods, graphite minerals, graphite powder, and chemically modified graphite. In some embodiments, the graphite particles can include thinned graphite. In some embodiments, the graphite particles may include at least one of recycled graphite (e.g., graphite recovered from used products or manufacturing processes), micronized graphite (e.g., finely ground graphite), or by-product graphite (e.g., graphite obtained as a secondary material from a spherical graphite production process).

In some embodiments, the graphite particles can include flaky particles. The graphite particles can have a thickness and a lateral dimension. In some embodiments, the graphite particles can have a lateral dimension of at least about 2 μm, at least about 2.5 μm, at least about 3 μm, at least about 3.5 μm, at least about 4 μm, at least about 4.5 μm, at least about 5 μm, at least about 5.5 μm, at least about 6 μm, at least about 6.5 μm, at least about 6 μm, at least about 7.5 μm, at least about 8 μm, at least about 8.5 μm, at least about 9 μm, at least about 9.5 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 150 μm, at least about 200 μm, at least about 250 μm, at least about 300 μm, or at least about 350 μm. In some embodiments, the graphite particles can have a lateral dimension of no more than about 400 μm, no more than about 350 μm, no more than about 300 μm, no more than about 250 μm, no more than about 200 μm, no more than about 150 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 9.5 μm, no more than about 9 μm, no more than about 8.5 μm, no more than about 8 μm, no more than about 7.5 μm, no more than about 7 μm, no more than about 6.5 μm, no more than about 6 μm, no more than about 5.5 μm, no more than about 5 μm, no more than about 4.5 μm, no more than about 4 μm, no more than about 3.5 μm, no more than about 3 μm, or no more than about 2.5 μm. Combinations of the above-referenced lateral dimensions are also possible (e.g., at least about 2 μm and no more than about 400 μm or at least about 4 μm and no more than about 9 μm). In some embodiments, the graphite particles can have a lateral dimension of about 2 μm, about 2.5 μm, about 3 μm, about 3.5 μm, about 4 μm, about 4.5 μm, about 5 μm, about 5.5 μm, about 6 μm, about 6.5 μm, about 6 μm, about 7.5 μm, about 8 μm, about 8.5 μm, about 9 μm, about 9.5 μm, about 10 μm, about 20 μm, about 30 μm, about 40 μm, about 50 μm, about 60 μm, about 70 μm, about 80 μm, about 90 μm, about 100 μm, about 150 μm, about 200 μm, about 250 μm, about 300 μm, about 350 μm, or about 400 μm.

In some embodiments, the graphite particles can have a thickness dimension of at least about 5 nm, at least about 10 nm, at least about 20 nm, at least about 30 nm, at least about 40 nm, at least about 50 nm, at least about 60 nm, at least about 70 nm, at least about 80 nm, at least about 90 nm, at least about 100 nm, at least about 200 nm, at least about 300 nm, at least about 400 nm, at least about 500 nm, at least about 600 nm, at least about 700 nm, at least about 800 nm, at least about 900 nm, at least about 1 μm, at least about 1.5 μm, at least about 2 μm, at least about 2.5 μm, at least about 3 μm, at least about 3.5 μm, at least about 4 μm, at least about 4.5 μm, at least about 5 μm, at least about 10 μm, at least about 15 μm, at least about 20 μm, at least about 25 μm, at least about 30 μm, at least about 35 μm, at least about 40 μm, or at least about 45 μm. In some embodiments, the graphite particles can have a thickness dimension of no more than about 50 μm, no more than about 45 μm, no more than about 40 μm, no more than about 35 μm, no more than about 30 μm, no more than about 25 μm, no more than about 20 μm, no more than about 15 μm, no more than about 10 μm, no more than about 9 μm, no more than about 8 μm, no more than about 7 μm, no more than about 6 μm, no more than about 5 μm, no more than about 4.5 μm, no more than about 4 μm, no more than about 3.5 μm, no more than about 3 μm, no more than about 2.5 μm, no more than about 2 μm, no more than about 1.5 μm, no more than about 1 μm, no more than about 900 nm, no more than about 800 nm, no more than about 700 nm, no more than about 600 nm, no more than about 500 nm, no more than about 400 nm, no more than about 300 nm, no more than about 200 nm, no more than about 100 nm, no more than about 90 nm, no more than about 80 nm, no more than about 70 nm, no more than about 60 nm, no more than about 50 nm, no more than about 40 nm, no more than about 30 nm, no more than about 20 nm, or no more than about 10 nm. Combinations of the above-referenced thickness dimensions are also possible (e.g., at least about 5 nm and no more than about 50 μm or at least about 50 nm and no more than about 500 nm), inclusive of all values and ranges therebetween. In some embodiments, the graphite particles can have a thickness dimension of about 5 nm, about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 1.5 μm, about 2 μm, about 2.5 μm, about 3 μm, about 3.5 μm, about 4 μm, about 4.5 μm, about 5 μm, about 6 μm, about 7 μm, about 8 μm, about 9 μm, about 10 μm, about 15 μm, about 20 μm, about 25 μm, about 30 μm, about 35 μm, about 40 μm, about 45 μm, or about 50 μm.

In some embodiments, the plurality of layered particles can include graphene particles (e.g., FLG particles).

In some embodiments, the graphene particles can have any of the physical properties of the graphene flakes described in the '542 patent. In some embodiments, the graphene particles can have a lateral dimension of at least about 10 nm, at least about 50 nm, at least about 100 nm, at least about 500 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 110 μm, at least about 120 μm, at least about 130 μm, or at least about 140 μm. In some embodiments, the graphene particles can have a lateral dimension of no more than about 150 μm, no more than about 140 μm, no more than about 130 μm, no more than about 120 μm, no more than about 110 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 5 μm, no more than about 1 μm, no more than about 500 nm, no more than about 100 nm, or no more than about 50 nm. Combinations of the above-referenced lateral dimensions of the graphene particles are also possible (e.g., at least about 10 nm and no more than about 150 μm or at least about 10 μm and no more than about 100 μm), inclusive of all values and ranges therebetween. In some embodiments, the graphene particles can have a lateral dimension of about 10 nm, about 50 nm, about 100 nm, about 500 nm, about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, about 100 μm, about 110 μm, about 120 μm, about 130 μm, about 140 μm, or about 150 μm.

In some embodiments, the graphene particles can have a thickness of at least about 1 graphene layer, at least about 2 graphene layers, at least about 3 graphene layers, at least about 4 graphene layers, at least about 5 graphene layers, at least about 6 graphene layers, at least about 7 graphene layers, at least about 8 graphene layers, at least about 9 graphene layers, at least about 10 graphene layers, at least about 11 graphene layers, at least about 12 graphene layers, at least about 13 graphene layers, at least about 14 graphene layers, at least about 15 graphene layers, at least about 16 graphene layers, at least about 17 graphene layers, at least about 18 graphene layers, or at least about 19 graphene layers. In some embodiments, the graphene particles can have a thickness of no more than about 20 graphene layers, no more than about 19 graphene layers, no more than about 18 graphene layers, no more than about 17 graphene layers, no more than about 16 graphene layers, no more than about 15 graphene layers, no more than about 14 graphene layers, no more than about 13 graphene layers, no more than about 12 graphene layers, no more than about 11 graphene layers, no more than about 10 graphene layers, no more than about 9 graphene layers, no more than about 8 graphene layers, no more than about 7 graphene layers, no more than about 6 graphene layers, no more than about 5 graphene layers, no more than about 4 graphene layers, no more than about 3 graphene layers, or no more than about 2 graphene layers. Combinations of the above-referenced thicknesses of the graphene particles are also possible (e.g., at least about 1 graphene layer and no more than about 20 graphene layers or at least about 5 graphene layers and no more than about 10 graphene layers), inclusive of all values and ranges therebetween. In some embodiments, the graphene particles can have a thickness of about 1 graphene layer, about 2 graphene layers, about 3 graphene layers, about 4 graphene layers, about 5 graphene layers, about 6 graphene layers, about 7 graphene layers, about 8 graphene layers, about 9 graphene layers, about 10 graphene layers, about 11 graphene layers, about 12 graphene layers, about 13 graphene layers, about 14 graphene layers, about 15 graphene layers, about 16 graphene layers, about 17 graphene layers, about 18 graphene layers, about 19 graphene layers, or about 20 graphene layers.

In some embodiments, the graphene particles can have an aspect ratio of at least about 50, at least about 100, at least about 500, at least about 1,000, at least about 5,000, at least about 10,000, at least about 20,000, at least about 30,000, or at least about 40,000. In some embodiments, the graphene particles can have an aspect ratio of no more than about 50,000, no more than about 40,000, no more than about 30,000, no more than about 20,000, no more than about 10,000, no more than about 5,000, no more than about 1,000, no more than about 500, or no more than about 100. Combinations of the above-referenced aspect ratios are also possible (e.g., at least about 50 and no more than about 50,000 or at least about 500 and no more than about 5,000), inclusive of all values and ranges therebetween. In some embodiments, the graphene particles can have an aspect ratio of about 50, about 100, about 500, about 1,000, about 5,000, about 10,000, about 20,000, about 30,000, about 40,000, or about 50,000.

In some embodiments, the plurality of non-layered particles can include at least one of metal particles or metal oxide particles. In some embodiments, the metal particles can include silicon, tin, iron, magnesium, manganese, aluminum, lead, gold, silver, titanium, platinum, palladium, ruthenium, copper, nickel, rhodium, and alloys thereof. In some embodiments, the plurality of non-layered particles include silicon particles.

In some embodiments, the plurality of non-layered particles can include metal oxide particles. In some embodiments, the metal oxide particles can be selected from the group consisting of oxides of silicon, tin, iron, magnesium, manganese, aluminum, lead, gold, silver, titanium, platinum, palladium, ruthenium, copper, nickel, rhodium, tungsten, cobalt, or molybdenum, and alloys thereof.

In some embodiments, the non-layered particles can have an average dimension (D50) of at least about 0.1 μm, at least about 0.2 μm, at least about 0.3 μm, at least about 0.4 μm, at least about 0.5 μm, at least about 1 μm, at least about 1.5 μm, at least about 2.0 μm, at least about 2.5 μm, at least about 3.0 μm, at least about 3.5 μm, at least about 4 μm, at least about 4.5 μm, at least about 5 μm, at least about 5.5 μm, at least about 6 μm, at least about 6.5 μm, at least about 7 μm, at least about 7.5 μm, at least about 8 μm, at least about 8.5 μm, at least about 9 μm, at least about 9.5 μm, at least about 10 μm, at least about 10.5 μm, at least about 11 μm, or at least about 11.5 μm. In some embodiments, the non-layered particles can have an average dimension (D50) of no more than about 12 μm, no more than about 11.5 μm, no more than about 11 μm, no more than about 10.5 μm, no more than about 10 μm, no more than about 9.5 μm, no more than about 9 μm, no more than about 8.5 μm, no more than about 8 μm, no more than about 7.5 μm, no more than about 7 μm, no more than about 6.5 μm, no more than about 6 μm, no more than about 5.5 μm, no more than about 5 μm, or no more than about 4.5 μm. Combinations of the above-referenced diameters of the non-layered particles are also possible (e.g., at least about 0.1 μm and no more than about 12 μm or at least about 0.3 μm and no more than about 8 μm), inclusive of all values and ranges therebetween. In some embodiments, the non-layered particles can have an average dimension (D50) of about 4 μm, about 4.5 μm, about 5 μm, about 5.5 μm, about 6 μm, about 6.5 μm, about 7 μm, about 7.5 μm, about 8 μm, about 8.5 μm, about 9 μm, about 9.5 μm, about 10 μm, about 10.5 μm, about 11 μm, about 11.5 μm, or about 12 μm.

In some embodiments, the non-layered particles can have a sphericity of at least about 0.7, at least about 0.75, at least about 0.8, at least about 0.85, at least about 0.9, at least about 0.91, at least about 0.92, at least about 0.93, at least about 0.94, at least about 0.95, at least about 0.96, at least about 0.97, at least about 0.98, at least about 0.99, at least about 0.991, at least about 0.992, at least about 0.993, at least about 0.994, at least about 0.995, at least about 0.996, at least about 0.997, at least about 0.998, or at least about 0.999. In some embodiments, the non-layered particles can have a sphericity of no more than about 1, no more than about 0.999, no more than about 0.998, no more than about 0.997, no more than about 0.996, no more than about 0.995, no more than about 0.994, no more than about 0.993, no more than about 0.992, no more than about 0.991, no more than about 0.99, no more than about 0.98, no more than about 0.97, no more than about 0.96, no more than about 0.95, no more than about 0.94, no more than about 0.93, no more than about 0.92, no more than about 0.91, no more than about 0.9, no more than about 0.85, no more than about 0.8, or no more than about 0.75. Combinations of the above-referenced sphericities of the non-layered particles are also possible (e.g., at least about 0.7 and no more than about 1 or at least about 0.95 and no more than about 0.995), inclusive of all values and ranges therebetween. In some embodiments, the non-layered particles can have a sphericity of about 0.7, about 0.75, about 0.8, about 0.85, about 0.9, about 0.91, about 0.92, about 0.93, about 0.94, about 0.95, about 0.96, about 0.97, about 0.98, about 0.99, about 0.991, about 0.992, about 0.993, about 0.994, about 0.995, about 0.996, about 0.997, about 0.998, about 0.999, or about 1.

In some embodiments, the plurality of non-layered particles can be present in an amount of at least from about 50 wt % to no more than about 98 wt % within the mixture formed at step 12. In some embodiments, the plurality of non-layered particles can make up at least about 50 wt %, at least about 55 wt %, at least about 60 wt %, at least about 65 wt %, at least about 70 wt %, at least about 75 wt %, at least about 80 wt %, at least about 85 wt %, or at least about 90 wt %, of the mixture formed at step 12. In some embodiments, the additive can make up no more than about 99 wt %, no more than about 98 wt %, no more than about 97 wt %, no more than about 96 wt %, no more than about 95 wt %, no more than about 90 wt %, no more than about 85 wt %, no more than about 80 wt %, no more than about 75 wt %, no more than about 70 wt %, or no more than about 65 wt %, of the mixture formed at step 12. Combinations of the above-referenced weight percentages are also possible (e.g., at least about 50 wt % and no more than about 99 wt % or at least about 60 wt % and no more than about 95 wt %), inclusive of all values and ranges therebetween.

At step 12, the mixing step can further include mixing an additive with the plurality of layered particles and the plurality of non-layered particles. In some embodiments, the additive can be a conductive additive. In some embodiments, the additive may include a carbon-based conductive additive. In some embodiments, the additive can include at least one of carbon black, carbon nanotubes, carbon fibers, carbonaceous materials, or recycled carbonaceous materials. In some embodiments, the additive can be in the form of particles, fibers, or bulk material. In some embodiments, the additive can be present as a powder.

In some embodiments, the additive can be present in an amount of from at least about 0 wt % to no more than about 25 wt % within the mixture formed at step 12. In some embodiments, the additive can make up at least about 0 wt %, at least about 0.5 wt %, at least about 1 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, at least about 14 wt %, or at least about 15 wt % of the mixture formed at step 12. In some embodiments, the additive can make up no more than about 25 wt %, no more than about 24 wt %, no more than about 23 wt %, no more than about 22 wt %, no more than about 21 wt %, no more than about 20 wt %, no more than about 19 wt %, no more than about 18 wt %, no more than about 17 wt %, no more than about 16 wt %, no more than about 15 wt %, or no more than about 10 wt %, of the mixture formed at step 12. Combinations of the above-referenced weight percentages are also possible (e.g., at least about 0 wt % and no more than about 25 wt % or at least about 5 wt % and no more than about 15 wt %), inclusive of all values and ranges therebetween.

In some embodiments, the additive can include at least one of carbon black, or a plurality of carbon nanotubes. In some embodiments, the carbon black can be characterized by its ASTM designation. In some embodiments, the carbon black can include N110, N220, N234, N326, N330, N339, N351, N375, N550, N660, N774, N990, or any combination thereof. In some embodiments, the carbon black can have a particle size of about 20 nm, about 30 nm, about 40 nm, about 50 nm, about 60 nm, about 70 nm, about 80 nm, about 90 nm, about 100 nm, about 150 nm, about 200 nm, about 250 nm, about 300 nm, about 350 nm, about 400 nm, or about 450 nm, inclusive of all values and ranges therebetween. In some embodiments, the carbon black can include a mix of several grades of carbon black. In some embodiments, the additive can include a plurality of carbon nanotubes. The carbon nanotubes may be single-walled, multi-walled, or a combination of both.

At step 12, the mixing can further include mixing a lithium salt with the plurality of layered particles and the plurality of non-layered particles. In some embodiments, the lithium salt may be selected from at least one of lithium fluoride (LiF), lithium bis(oxalato)borate (LiBOB), lithium carbonate (Li₂CO₃), lithium acetate (LiOAc), lithium hexafluorophosphate (LiPF₆), lithium rocksalt (Li₃V₂O₅), lithium-cobalt oxide (LiCoO₂), or any lithium-carbon compound.

In some embodiments, the lithium salt can be present in an amount of at least from about 0 wt % to no more than about 15 wt % within the mixture formed at step 12. In some embodiments, the lithium salt can make up at least about 0 wt %, at least about 0.5 wt %, at least about 1 wt %, at least about 2 wt %, at least about 3 wt %, at least about 4 wt %, at least about 5 wt %, at least about 6 wt %, at least about 7 wt %, at least about 8 wt %, at least about 9 wt %, or at least about 10 wt %, of the mixture formed at step 12. In some embodiments, the lithium salt can make up no more than about 15 wt %, no more than about 14 wt %, no more than about 13 wt %, no more than about 12 wt %, no more than about 11 wt %, no more than about 10 wt %, no more than about 9 wt %, no more than about 8 wt %, no more than about 7 wt %, no more than about 6 wt %, no more than about 5 wt %, or no more than about 3 wt %, of the mixture formed at step 12. Combinations of the above-referenced weight percentages are also possible (e.g., at least about 0 wt % and no more than about 15 wt % or at least about 1 wt % and no more than about 5 wt %), inclusive of all values and ranges therebetween.

As used herein, the term “milling” refers to the operation of breaking a solid material into a desired grain or particle size. In some embodiments, milling refers to grinding by compression or by friction.

In some embodiments, the milling includes using at least one of a jet mill, a hammer mill, a shearing mill, a roller mill, a shock shearing mill, a ball mill, attritor (also known as stirred ball mill), or a tumbling mill.

At step 13, milling the plurality of layered particles and the plurality of non-layered particles in a controlled environment is be performed for to ensure the highest yield and/or quality of the composite. In some embodiments, the milling can be performed for at least about 10 minutes, at least about 20 minutes, at least about 30 minutes, at least about 50 minutes, at least about 60 minutes, at least about 1 hour, at least about 2 hours, at least about 3 hours, at least about 4 hours, at least about 5 hours, at least about 6 hours, at least about 7 hours, at least about 8 hours, at least about 10 hours, at least about 12 hours, at least about 14 hours, at least about 16 hours, at least about 18 hours, at least about 20 hours, at least about 22 hours, at least about 24 hours, at least about 48 hours, or at least about 72 hours. In some embodiments, the milling can be performed for no more than about 72 hours, no more than about 72 hours, no more than about 48 hours, no more than about 24 hours, no more than about 22 hours, no more than about 20 hours, no more than about 18 hours, no more than about 16 hours, no more than about 14 hours, no more than about 12 hours, no more than about 10 hours, no more than about 8 hours, no more than about 7 hours, no more than about 6 hours, no more than about 5 hours, no more than about 4 hours, no more than about 3 hours, no more than about 2 hours, no more than about 1 hour, no more than about 50 minutes, no more than about 30 minutes, or no more than about 20 minutes. Combinations of the above-referenced milling durations are also possible (e.g., at least about 10 minute and no more than about 72 hours or at least about 1 hour and no more than about 10 hours), inclusive of all values and ranges therebetween. In some embodiments, the milling can be performed for about 10 minutes, about 20 minutes, about 30 minutes, about 50 minutes, about 60 minutes, about 1 hour, about 2 hours, about 3 hours, about 4 hours, about 5 hours, about 6 hours, about 7 hours, about 8 hours, about 10 hours, about 12 hours, about 14 hours, about 16 hours, about 18 hours, about 20 hours, about 22 hours, about 24 hours, about 48 hours, or about 72 hours.

In some embodiments, the milling can be performed at a speed of at least about 300 rpm, at least about 350 rpm, at least about 400 rpm, at least about 450 rpm, at least about 500 rpm, at least about 550 rpm, least about 600 rpm, least about 650 rpm, at least about 700 rpm, at least about 750 rpm, at least about 800 rpm, at least about 850 rpm, at least about 900 rpm, at least about 950 rpm, at least about 1000 rpm, at least about 1100 rpm, at least about 1150 rpm, at least about 1200 rpm, at least about 1250 rpm, at least about 1300 rpm, at least about 1350 rpm, at least about 1400 rpm, at least about 1450 rpm, or at least about 1500 rpm. In some embodiments, the milling can be performed at a speed of no more than about 2500 rpm, no more than about 2400 rpm, no more than about 2300 rpm, no more than about 2200 rpm, no more than about 2100 rpm, no more than about 2000 rpm, no more than about 1950 rpm, no more than about 1900 rpm, no more than about 1850 rpm, no more than about 1800 rpm, no more than about 1750 rpm, no more than about 1700 rpm, no more than about 1650 rpm, no more than about 1600 rpm, no more than about 1550 rpm, or no more than about 1500 rpm. Combinations of the above-referenced speeds are also possible (e.g., at least about 300 rpm and no more than about 2500 rpm or at least about 750 and no more than about 2000 rpm), inclusive of all values and ranges therebetween.

In some embodiments, the milling can be performed at a speed of about 300 rpm, about 350 rpm, about 400 rpm, about 450 rpm, about 500 rpm, about 550 rpm, least about 600 rpm, least about 650 rpm, about 700 rpm, about 750 rpm, about 800 rpm, about 850 rpm, about 900 rpm, about 950 rpm, about 1000 rpm, about 1100 rpm, about 1150 rpm, about 1200 rpm, about 1250 rpm, about 1300 rpm, about 1350 rpm, about 1400 rpm, about 1450 rpm, or about 1500 rpm. In some embodiments, the milling can be performed about 760 rpm.

In some embodiments, the speed of the rotation at which the milling is performed can be configured to reduce the initial thickness of graphite particles without substantially affecting its lateral size.

At step 13, in some embodiments, the milling can be performed in the presence of a milling media. In some embodiments, the milling media can include a plurality of balls having a diameter ranging from about 0.5 mm to about 100 mm. In some embodiments, the plurality of balls can have diameters of at least about 0.5 mm, at least about 1 mm, at least about 5 mm, at least about 10 mm, at least about 15 mm, at least about 20 mm, at least about 25 mm, at least about 30 mm, at least about 35 mm, at least about 40 mm, at least about 45 mm, or at least about 50 mm. In some embodiments, the plurality of balls can have diameters of no more than about 100 mm, no more than about 95 mm, no more than about 90 mm, no more than about 85 mm, no more than about 80 mm, no more than about 75 mm, or no more than about 70 mm. Combinations of the above-referenced diameters are also possible (e.g., at least about 0.5 mm and no more than about 100 mm or at least about 6 mm and no more than about 80 mm), inclusive of all values and ranges therebetween.

In some embodiments, the milling media can include a first plurality of balls having a first diameter and a second plurality of balls having a second diameter different than the first diameter.

In some embodiments, the milling media may be made of a plastic material. In some embodiments, the milling media may have a hardness on the Brinell Scale in the range of about 3 to about 100. In some embodiments, the milling media may be formed from at least one of polyacetals, polyacrylates, such as polymethylmethacrylate, polycarbonate, polystyrene, poly-propylene, polyethylene, polytetrafluoroethylene, polyethyleneimide, polyvinylchloride, polyamine-imide, phenolics, or formaldehyde-based thermosetting resins.

In some embodiments, the milling media can be made of at least one of a metal or a metal alloy. In some embodiments, the milling media can be made of a ceramic (e.g., alumina). In some embodiments, the milling media may include at least one of stainless steel, tungsten carbide, yttria-stabilized zirconia, or zirconium oxide.

In some embodiments, the second controlled environment can have a pressure of no more than about 0.30 bar absolute, no more than about 0.29 bar absolute, no more than about 0.28 bar absolute, no more than about 0.27 bar absolute, no more than about 0.26 bar absolute, no more than about 0.25 bar absolute, no more than about 0.24 bar absolute, no more than about 0.23 bar absolute, no more than about 0.22 bar absolute, no more than about 0.21 bar absolute, no more than about 0.20 bar absolute, no more than about 0.19 bar absolute, no more than about 0.18 bar absolute, no more than about 0.17 bar absolute, no more than about 0.16 bar absolute, no more than about 0.15 bar absolute, no more than about 0.14 bar absolute, no more than about 0.13 bar absolute, no more than about 0.12 bar absolute, no more than about 0.11 bar absolute, no more than about 0.10 bar absolute, no more than about 0.09 bar absolute, no more than about 0.08 bar absolute, no more than about 0.07 bar absolute, no more than about 0.06 bar absolute, no more than about 0.05 bar absolute, no more than about 0.04 bar absolute, no more than about 0.03 bar absolute, no more than about 0.02 bar absolute, or no more than about 0.01 bar absolute.

In some embodiments, the second controlled environment can have a pressure of about 0.30 bar absolute, about 0.29 bar absolute, about 0.28 bar absolute, about 0.27 bar absolute, about 0.26 bar absolute, about 0.25 bar absolute, about 0.24 bar absolute, about 0.23 bar absolute, about 0.22 bar absolute, about 0.21 bar absolute, about 0.20 bar absolute, about 0.19 bar absolute, about 0.18 bar absolute, about 0.17 bar absolute, about 0.16 bar absolute, about 0.15 bar absolute, about 0.14 bar absolute, about 0.13 bar absolute, about 0.12 bar absolute, about 0.11 bar absolute, about 0.10 bar absolute, about 0.09 bar absolute, about 0.08 bar absolute, about 0.07 bar absolute, about 0.06 bar absolute, about 0.05 bar absolute, about 0.04 bar absolute, about 0.03 bar absolute, about 0.02 bar absolute, or about 0.01 bar absolute.

In some embodiments, the second controlled environment can include at least about 5 vol %, at least about 10 vol %, at least about 15 vol %, at least about 20 vol %, at least about 25 vol %, at least about 30 vol %, at least about 35 vol %, at least about 40 vol %, at least about 45 vol %, at least about 50 vol %, at least about 55 vol %, at least about 60 vol %, at least about 65 vol %, at least about 70 vol %, at least about 75 vol %, at least about 80 vol %, at least about 85 vol %, at least about 90 vol %, at least about 95 vol %, at least about 96 vol %, at least about 97 vol %, at least about 98 vol %, at least about 99 vol %, at least about 99.5 vol %, at least about 99.6 vol %, at least about 99.7 vol %, at least about 99.8 vol %, or at least about 99.9 vol % inert gas. In some embodiments, the second controlled environment can include no more than about 100 vol %, no more than about 99.9 vol %, no more than about 99.8 vol %, no more than about 99.7 vol %, no more than about 99.6 vol %, no more than about 99.5 vol %, no more than about 99 vol %, no more than about 98 vol %, no more than about 97 vol %, no more than about 96 vol %, no more than about 95 vol %, no more than about 90 vol %, no more than about 85 vol %, no more than about 80 vol %, no more than about 75 vol %, no more than about 70 vol %, no more than about 65 vol %, no more than about 60 vol %, no more than about 55 vol %, no more than about 50 vol %, no more than about 45 vol %, no more than about 40 vol %, no more than about 35 vol %, no more than about 30 vol %, no more than about 25 vol %, no more than about 20 vol %, no more than about 15 vol %, or no more than about 10 vol % inert gas. Combinations of the above-referenced temperatures are also possible (e.g., at least about at least about 5 vol % and no more than about 100 vol %, or at least about 99.5 vol % and no more than about 100 vol %), inclusive of all values and ranges therebetween.

In some embodiments, the second controlled environment can include about 100 vol %, about 99.9 vol %, about 99.8 vol %, about 99.7 vol %, about 99.6 vol %, about 99.5 vol %, about 99 vol %, about 98 vol %, about 97 vol %, about 96 vol %, about 95 vol %, about 90 vol %, about 85 vol %, about 80 vol %, about 75 vol %, about 70 vol %, about 65 vol %, about 60 vol %, about 55 vol %, about 50 vol %, about 45 vol %, about 40 vol %, about 35 vol %, about 30 vol %, about 25 vol %, about 20 vol %, about 15 vol %, or about 10 vol %, inert gas.

In some embodiments, the inert gas can be selected from at least one of nitrogen (N₂), helium (He), neon (Ne), argon (Ar), krypton (Kr), or xenon (Xe). In some embodiments, the inert gas includes at least one of Ar, or N₂. The choice of inert gas can depend on the specific requirements of the material being processed. In some embodiments, the use of an inert atmosphere in milling aids in preventing oxidation and other unwanted chemical reactions that could degrade the quality of the milled materials.

In some embodiments, the second controlled environment can have a pressure that is less than atmospheric pressure (i.e., less than about 1 bar absolute) and/or a concentration of inert gas. Without being bound by theory, one of the benefits of operating (i.e., milling) under reduced pressure (e.g., under vacuum) and/or an inert environment is the enhancement of binding interactions between the composite-forming particles. For example, the process of exfoliating and breaking down graphite to form graphene can result in chemically reactive intermediates on the graphene surface. In an atmospheric environment, these intermediates can react with molecules such as water, oxygen, or carbon dioxide, effectively quenching their reactivity. However, under reduced pressure or inert atmosphere, these atmospheric molecules are absent. This allows the reactive intermediates to interact with the silicon surface, leading to the formation of strong covalent bonds. Consequently, more robust silicon-graphene composites can be formed compared to those produced under atmospheric pressure. These stronger composites help to reduce battery degradation during charge-discharge cycles, thereby improving the battery's lifespan.

In some embodiments, the second controlled environment can have a relative humidity of at least about 0%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%. In some embodiments, the controlled environment can have a relative humidity of no more than 100%, no more than about 95%, no more than about 90%, no more than about 85%, no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, no more than about 15%, no more than about 10%, no more than about 8%, no more than about 6%, no more than about 4%, or no more than about 2%. Combinations of the above-referenced values are also possible (e.g., at least about at least about 0% and no more than about 100%, or at least about 30% and no more than about 90%), inclusive of all values and ranges therebetween.

In some embodiments, the second controlled environment has a temperature of at least about −10° C., at least about −5° C., at least about 0° C., at least about 5° C., at least about 10° C., at least about 15° C., at least about 20° C., at least about 25° C., at least about 30° C., at least about 35° C., at least about 40° C., at least about 45° C., at least about 50° C., at least about 55° C., at least about 60° C., at least about 65° C., at least about 70° C., at least about 75° C., at least about 80° C., at least about 85° C., at least about 90° C., at least about 95° C., at least about 100° C., at least about 110° C., at least about 120° C., at least about 130° C., at least about 140° C., at least about 150° C., at least about 160° C., at least about 170° C., at least about 180° C., at least about 190° C., at least about 200° C., at least about 210° C., at least about 220° C., at least about 230° C., or at least about 240° C.,. In some embodiments, the second controlled environment has a temperature of no more than about 250° C., no more than about 245° C., no more than about 240° C., no more than about 235° C., no more than about 230° C., no more than about 225° C., no more than about 220° C., no more than about 215° C., no more than about 210° C., no more than about 205° C., no more than about 200° C., no more than about 195° C., no more than about 190° C., no more than about 185° C., no more than about 180° C., no more than about 175° C., no more than about 170° C., no more than about 165° C., no more than about 160° C., no more than about 155° C., no more than about 150° C., no more than about 145° C., no more than about 140° C., no more than about 135° C., no more than about 130° C., no more than about 125° C., no more than about 120° C., no more than about 115° C., no more than about 110° C., no more than about 105° C., no more than about 100° C., no more than about 95° C., no more than about 90° C., no more than about 85° C., no more than about 80° C., no more than about 75° C., no more than about 70° C., no more than about 65° C., no more than about 60° C., no more than about 55° C., no more than about 50° C., no more than about 45° C., no more than about 40° C., no more than about 35° C., or no more than about 30° C. Combinations of the above-referenced temperatures are also possible (e.g., at least about −10° C. and no more than about 250° C. or at least about 20° C. and no more than about 30° C.), inclusive of all values and ranges therebetween.

At step 13, milling not only breaks a plurality of layered materials into their layers (e.g., desired grain or particle size) while increasing the surface area but also concurrently combines these layers with a plurality of non-layered materials and any other materials present. For examples, milling procedure not only exfoliates graphite or FLG graphene into graphene sheets with a large surface area but also simultaneously integrates these graphene sheets with silicon and any other materials present. As a result, exfoliated graphene can coat the silicon surface during the composite formation process. This coating can enhance the electrical accessibility of silicon particles during the battery cycling process, leading to an increase in the specific capacity of the battery anode.

In some embodiments, the plurality of layered particles can include graphite particles, and graphene particles are produced during milling, at step 13. The milling process, when performed under controlled conditions such as low pressure, can enhance the exfoliation of graphite. This results in a larger surface area of the resulting graphene compared to that obtained from milling under uncontrolled conditions. Specifically, in some embodiments, the surface area of the graphene produced under controlled conditions (e.g., in an inert atmosphere and/or under low pressure, for example, no more than about 0.3 bar absolute) at step 13 can be larger than the surface area of graphene obtained by milling in an uncontrolled environment by a factor of about 1.1, about 1.2, about 1.3, about 1.4, about 1.5, about 1.6, about 1.7, about 1.8, about 1.9. about 2.0, about 2.1, about 2.2, about 2.3, about 2.4, about 2.5, about 3.0, about 3.5, about 4.0, about 5.0, about 6.0, about 7.0, about 8.0, about 9.0, about 10.0, about 20.0, about 30.0, about 40.0, or about 50.0, inclusive of all values and ranges therebetween.

In some embodiments, the graphene obtained by method 10 according to multiple embodiments described herein, can have a surface area at least about 250 m²/g BET (Brunnauer-Emmett-Teller), at least about 260 m²/g BET, at least about 270 m²/g BET, at least about 280 m²/g BET, at least about 290 m²/g BET, at least about 300 m²/g BET, at least about 310 m²/g BET, at least about 320 m²/g BET, at least about 330 m²/g BET, at least about 340 m²/g BET, at least about 350 m²/g BET, at least about 360 m²/g BET, at least about 370 m²/g BET, at least about 380 m²/g BET, at least about 390 m²/g BET, at least about 400 m²/g BET, at least about 410 m²/g BET, at least about 420 m²/g BET, at least about 430 m²/g BET, at least about 440 m²/g BET, at least about 450 m²/g BET, at least about 460 m²/g BET, at least about 470 m²/g BET, at least about 480 m²/g BET, at least about 490 m²/g BET, at least about 500 m²/g BET, at least about 510 m²/g BET, at least about 520 m²/g BET, at least about 530 m²/g BET, at least about 540 m²/g BET, at least about 550 m²/g BET, at least about 560 m²/g BET, at least about 570 m²/g BET, at least about 580 m²/g BET, at least about 590 m²/g BET, at least about 600 m²/g BET, at least about 610 m²/g BET, at least about 620 m²/g BET, at least about 630 m²/g BET, at least about 640 m²/g BET, at least about 650 m²/g BET, at least about 660 m²/g BET, at least about 670 m²/g BET, at least about 680 m²/g BET, at least about 690 m²/g BET, at least about 700 m²/g BET, at least about 710 m²/g BET, at least about 720 m²/g BET, at least about 730 m²/g BET, at least about 740 m²/g BET, or at least about 750 m²/g BET.

In some embodiments, the milling step 13 can increase the surface area of the graphene by a factor of about 1.1, about 1.2, about 1.5, about 2, about 2.5, about 3, about 3.5, about 4, about 4.5, about 5, about 5.5, about 6, about 6.5, about 7, about 7.5, about 8, about 8.5, about 9, about 9.5, about 10, about 10.5, about 11, about 11.5, about 12, about 12.5, about 13, about 13.5, about 14, about 14.5, or about 15.

At step 14, in some embodiments, post-treating the composite obtained from step 13 can include coating surface of the composite with a carbon coating. In some embodiments, post-treating includes mixing the composite with a carbon-containing material (e.g., a carbon-rich material such as petroleum pitch) and at least partially carbonizing the carbon-containing material to form a conductive carbon coating layer on the surface of the composite. In some embodiments, at step 14, the composite are coated with a carbon-containing liquid or resin that is then carbonized to create a conductive carbon coating on the surface of the composite particles, and to reduce the surface area-to-volume ratio of the coated composite particles. In some embodiments, the conductive carbon coating may be amorphous or partially amorphous.

In some embodiments, the carbon-containing liquid can include a water-soluble saccharide such as glucose, sucrose, and/or corn starch. In some embodiments, the carbon-containing liquid can include an oil. In some embodiments, the carbon-containing liquid can include a synthetic oil, a polyalphaolephin, mineral oil, flaxseed oil, a plant-based oil, a seed-based oil, or any combination thereof. In some embodiments, the carbon-containing liquid can include an amphipathic carrier such as a modified starch and/or carbohydrates. In some embodiments, the carbon-containing liquid can include maltodextrin, cyclodextrin, hydroxypropyl methylcellulose (HPMC), polyvinyl alcohol (PVA) resin, epoxy resin, polyester resin, vinyl ester resin, styrene, or any combination thereof. In some embodiments, the carbon-containing liquid can include polyvinylchloride (PVC), plasticized PVC, polyvinylpyrrolidone (PVP), or any combination thereof.

In some embodiments, the coating can cause individual composite particles to agglomerate into larger structures. The coating can form a layer around the particles, which can lead to them sticking together through various interactions. Without being bound by a theory, this agglomeration may reduce the external surface area of the composite, which helps reduce rapid electrolyte depletion/evaporation and side reactions, while still maintaining a high internal surface area crucial for ion transport and electron mobility. The coating can also serve to protect the composite, improving its electrochemical stability and reducing the risk of material degradation. Additionally, the coating may help increase the composite's volumetric energy density by reducing porosity.

Step 14 includes mixing the composite with a carbon-rich material (e.g., petroleum pitch) for a pre-determined amount of time to form a carbon-rich layer on the surface of the composite. In some embodiments, the pre-determined amount of time can be at least about 10 minutes, at least about 20 minutes, at least about 30 minutes, at least about 40 minutes, at least about 50 minutes, at least about 1 hour, at least about 2 hours, at least about 3 hours, at least about 4 hours, at least about 5 hours, at least about 6 hours, at least about 8 hours, at least about 10 hours, at least about 12 hours, at least about 18 hours, or at least about 24 hours. In some embodiments, the pre-determined amount of time can be no more than about 4 days, no more than about 3 days, no more than about 2 days, no more than about 1 day, no more than about 20 hours, no more than about 18 hours, no more than about 12 hours, or no more than about 10 hours. Combinations of the above-referenced temperatures are also possible (e.g., at least about 10 minutes and no more than about 1 hour or at least about 2 hours and no more than about 6 hours), inclusive of all values and ranges therebetween. In some embodiments, the pre-determined amount of time is 30 minutes.

In some embodiments, the carbon-rich material can make up at least about 1 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, at least about 15 wt %, at least about 20 wt %, at least about 25 wt %, at least about 30 wt %, or at least about 35 wt % of the total mass, including both the composite and the carbon-rich material. In some embodiments, the carbon-rich material can make up no more than about 40 wt %, no more than about 35 wt %, no more than about 30 wt %, no more than about 25 wt %, no more than about 20 wt %, no more than about 15 wt %, no more than about 10 wt %, no more than about 9 wt %, no more than about 8 wt %, no more than about 7 wt %, no more than about 6 wt %, no more than about 5 wt %, no more than about 4 wt %, no more than about 3 wt %, or no more than about 2 wt % of the total mass, including both the composite and the carbon-rich material. Combinations of the above-referenced weight percentages are also possible (e.g., at least about 1 wt % and no more than about 40 wt % or at least about 10 wt % and no more than about 30 wt %), inclusive of all values and ranges therebetween. In some embodiments, the carbon-rich material can make up about 1 wt %, about 2 wt %, about 3 wt %, about 4 wt %, about 5 wt %, about 6 wt %, about 7 wt %, about 8 wt %, about 9 wt %, about 10 wt %, about 15 wt %, about 20 wt %, about 25 wt %, about 30 wt %, about 35 wt %, or about 40 wt % of the total mass, including both the composite and the carbon-rich material.

Step 14 can further include heating the composite mixed with a carbon rich material to form a carbon-coated composite. The heat treatment at step 14 turns the carbon-rich layer into a carbon coating. In some embodiments, step 14 can include carbonizing the carbon-rich layer formed on the surface of the composite. Carbonization can be defined as a pyrolytic or thermochemical reaction, wherein heat is provided to create conductive carbon from a carbon-rich material. The carbonization promotes the removal of non-carbon materials from the carbon-coated composite, improving the conductivity of the carbon coating. In some embodiments, carbonization can be performed under a pressure greater than atmospheric pressure (e.g., at least about 0.1 bar (gauge), at least about 0.2 bar, at least about 0.3 bar, at least about 0.4 bar, at least about 0.5 bar, at least about 0.6 bar, at least about 0.7 bar, at least about 0.8 bar, at least about 0.9 bar, at least about 1 bar, at least about 2 bar, at least about 3 bar, at least about 4 bar, at least about 5 bar, at least about 6 bar, at least about 7 bar, at least about 8 bar, at least about 9 bar, or at least about 10 bar, inclusive of all values and ranges therebetween). In some embodiments, an acid can be used as an oxidizer for carbonization. In other words, step 14 can include acid treatment. In some embodiments, the acid can include phosphoric acid (H₃PO₄), sulfuric acid (H₂SO₄), nitric acid (HNO₃), hypochlorous acid (HOCl), hypobromous acid (HOBr), hypoiodous acid (HOI), iodic acid (HIO₃), or any combination thereof. In some embodiments, the carbonization can occur in an inert environment (e.g., with no oxygen or substantially no oxygen). In some embodiments, the carbonization can occur in an all-nitrogen environment. In some embodiments, the inert gas can include, nitrogen, argon, neon, or any combination thereof. In some embodiments, the carbonization can occur via decomposition of the carbon-containing material and extraction of volatiles.

In some embodiments, the carbonization can occur at a temperature of at least about 150° C., at least about 160° C., at least about 170° C., at least about 180° C., at least about 190° C., at least about 200° C., at least about 210° C., at least about 220° C., at least about 230° C., at least about 240° C., at least about 250° C., at least about 260° C., at least about 270° C., at least about 280° C., at least about 290° C., at least about 300° C., at least about 310° C., at least about 320° C., at least about 330° C., at least about 340° C., at least about 350° C., at least about 360° C., at least about 370° C., at least about 380° C., at least about 390° C., at least about 400° C., at least about 410° C., at least about 420° C., at least about 430° C., at least about 440° C., at least about 450° C., at least about 460° C., at least about 470° C., at least about 480° C., or at least about 490° C. In some embodiments, the carbonization can occur at a temperature of no more than about 500° C., no more than about 490° C., no more than about 480° C., no more than about 470° C., no more than about 460° C., no more than about 450° C., no more than about 440° C., no more than about 430° C., no more than about 420° C., no more than about 410° C., no more than about 400° C., no more than about 390° C., no more than about 380° C., no more than about 370° C., no more than about 360° C., no more than about 350° C., no more than about 340° C., no more than about 330° C., no more than about 320° C., no more than about 310° C., no more than about 300° C., no more than about 290° C., no more than about 280° C., no more than about 270° C., no more than about 260° C., no more than about 250° C., no more than about 240° C., no more than about 230° C., no more than about 220° C., no more than about 210° C., no more than about 200° C., no more than about 190° C., no more than about 180° C., no more than about 170° C., or no more than about 160° C. Combinations of the above-referenced temperatures are also possible (e.g., at least about 150° C. and no more than about 500° C. or at least about 250° C. and no more than about 450° C.), inclusive of all values and ranges therebetween. In some embodiments, the carbonization can occur at a temperature of about 150° C., about 160° C., about 170° C., about 180° C., about 190° C., about 200° C., about 210° C., about 220° C., about 230° C., about 240° C., about 250° C., about 260° C., about 270° C., about 280° C., about 290° C., about 300° C., about 310° C., about 320° C., about 330° C., about 340° C., about 350° C., about 360° C., about 370° C., about 380° C., about 390° C., about 400° C., about 410° C., about 420° C., about 430° C., about 440° C., about 450° C., about 460° C., about 470° C., about 480° C., about 490° C., or about 500° C.

In some embodiments, the carbonization can occur at a temperature of at least about 700° C., at least about 710° C., at least about 720° C., at least about 730° C., at least about 740° C., at least about 750° C., at least about 760° C., at least about 770° C., at least about 780° C., at least about 790° C., at least about 800° C., at least about 810° C., at least about 820° C., at least about 830° C., at least about 840° C., at least about 850° C., at least about 860° C., at least about 870° C., at least about 880° C., at least about 890° C., at least about 900° C., at least about 910° C., at least about 920° C., at least about 930° C., or at least about 940° C. In some embodiments, the carbonization can occur at a temperature of no more than about 1350° C., no more than about 1300° C., no more than about 1250° C., no more than about 1200° C., no more than about 1150° C., no more than about 1100° C., no more than about 1050° C., no more than about 1000° C., no more than about 950° C., no more than about 940° C., no more than about 930° C., no more than about 920° C., no more than about 910° C., no more than about 900° C., no more than about 890° C., no more than about 880° C., no more than about 870° C., no more than about 860° C., no more than about 850° C., no more than about 840° C., no more than about 830° C., no more than about 820° C., no more than about 810° C., no more than about 800° C., no more than about 790° C., no more than about 780° C., no more than about 770° C., no more than about 760° C., no more than about 750° C., no more than about 740° C., no more than about 730° C., no more than about 720° C., or no more than about 710° C.

Combinations of the above-referenced temperatures are also possible (e.g., at least about 700° C. and no more than about 1350° C. or at least about 750° C. and no more than about 900° C.), inclusive of all values and ranges therebetween. In some embodiments, the carbonization can occur at a temperature of about 700° C., about 710° C., about 720° C., about 730° C., about 740° C., about 750° C., about 760° C., about 770° C., about 780° C., about 790° C., about 800° C., about 810° C., about 820° C., about 830° C., about 840° C., about 850° C., about 860° C., about 870° C., about 880° C., about 890° C., about 900° C., about 910° C., about 920° C., about 930° C., about 940° C., about 950° C., about 1000° C., about 1050° C., about 1100° C., about 1150° C., about 1200° C., about 1250° C., about 1300° C., or about 1350° C.

In some embodiments, the carbonization can include multiple stages. For example, the carbonization may involve an initial heating ramp-up stage, followed by one or more subsequent heating stages to achieve the desired carbonization. In some embodiments, the heating ramp-up stage may be conducted at a controlled rate to obtain uniform carbonization of the carbon-containing material.

In some embodiments, the carbonization can have a duration (e.g., the duration of the total heating cycle or the duration of one of the stages of the carbonization process) of at least about 1 hour, at least about 1.1 hours, at least about 1.2 hours, at least about 1.3 hours, at least about 1.4 hours, at least about 1.5 hours, at least about 1.6 hours, at least about 1.7 hours, at least about 1.8 hours, at least about 1.9 hours, at least about 2 hours, at least about 2.1 hours, at least about 2.2 hours, at least about 2.3 hours, at least about 2.4 hours, at least about 2.5 hours, at least about 2.6 hours, at least about 2.7 hours, at least about 2.8 hours, at least about 2.9 hours, at least about 3 hours, at least about 4 hours, at least about 5 hours, at least about 6 hours, at least about 7 hours, at least about 8 hours, at least about 9 hours, at least about 10 hours, or at least about 11 hours. In some embodiments, the carbonization can have a duration of no more than about 12 hours, no more than about 11 hours, no more than about 10 hours, no more than about 9 hours, no more than about 8 hours, no more than about 7 hours, no more than about 6 hours, no more than about 5 hours, no more than about 4 hours, no more than about 3 hours, no more than about 2.9 hours, no more than about 2.8 hours, no more than about 2.7 hours, no more than about 2.6 hours, no more than about 2.5 hours, no more than about 2.4 hours, no more than about 2.3 hours, no more than about 2.2 hours, no more than about 2.1 hours, no more than about 2 hours, no more than about 1.9 hours, no more than about 1.8 hours, no more than about 1.7 hours, no more than about 1.6 hours, no more than about 1.5 hours, no more than about 1.4 hours, no more than about 1.3 hours, no more than about 1.2 hours, or no more than about 1.1 hours. Combinations of the above-referenced durations are also possible (e.g., at least about 1 hour and no more than about 12 hours or at least about 1.5 hours and no more than about 2.5 hours), inclusive of all values and ranges therebetween. In some embodiments, the carbonization can have a duration of about 1 hour, about 1.1 hours, about 1.2 hours, about 1.3 hours, about 1.4 hours, about 1.5 hours, about 1.6 hours, about 1.7 hours, about 1.8 hours, about 1.9 hours, about 2 hours, about 2.1 hours, about 2.2 hours, about 2.3 hours, about 2.4 hours, about 2.5 hours, about 2.6 hours, about 2.7 hours, about 2.8 hours, about 2.9 hours, about 3 hours, about 4 hours, about 5 hours, about 6 hours, about 7 hours, about 8 hours, about 9 hours, about 10 hours, about 11 hours, or about 12 hours.

At step 15, in some embodiments, the composite obtained from step 13 and/or step 14 can be formed into an anode. In some embodiments, the composite can serve as an active anode material for secondary electrodes and any necessary binder and/or conductive additives can be added into the composite to obtain a proper electrode. In some embodiments, step 15 can include dispensing or suspending the composite in a proper solvent to produce a slurry (e.g., a solution or a suspension). That is, the composite may be dissolved or dispersed in a proper solvent or solvent mixture such that the composite can be formed into a slurry that is suitable for dispensing or spreading onto a surface. In some embodiments, the slurry can include a multiphase liquid, wherein solid particles are suspended in the liquid. In some embodiments, the slurry can be homogeneous. In some embodiments, the slurry can be non-homogeneous.

In some embodiments, the slurry may further include a binder and/or a conductive additive. In some embodiments, step 15 can further include coating the slurry onto a current collector by using any suitable method available in the art (e.g., spray drying). In some embodiments, at step 15, the composite may be directly applied onto a current collector using a solvent-free technique.

In some embodiments, the electrode including the composite obtained under controlled environment according to multiple embodiments described herein, can have at least about 30%, at least about 31%, at least about 32%, at least about 33%, at least about 34%, at least about 35%, at least about 36%, at least about 37%, at least about 38%, at least about 39%, at least about 40%, at least about 41%, at least about 42%, at least about 43%, at least about 44%, at least about 45%, at least about 46%, at least about 47%, at least about 48%, at least about 49%, at least about 50%, at least about 55%, at least about 60%, at least about 65%, or at least about 70%, higher specific capacity than that of a composite obtained by milling without controlled atmosphere (i.e., the same composition produced under the same process without a controlled atmosphere).

In some embodiments, the electrode including the composite obtained under controlled environment according to multiple embodiments described herein, can have about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 55%, about 60%, about 65%, or about 70% higher specific capacity than that of a composite obtained by milling without a controlled atmosphere.

In some embodiments, batteries including the electrodes developed from the method 10 can have a cycle life of least about 1.2, at least about 1.5, at least about 1.7, at least about 2, at least about 2.2, at least about 2.5, at least about 2.7, at least about 3, at least about 3.2, at least about 3.5, at least about 3.7, at least about 4, at least about 4.2, at least about 4.5, at least about 4.7, at least about 5, at least about 5.5, at least about 6, at least about 6.5, at least about 7, at least about 7.5, at least about 8, at least about 8.5, at least about 9, at least about 9.5, or at least about 10 times longer than that of batteries including a composite obtained by milling without a controlled atmosphere.

At step 16, the electrode obtained from step 15 can be combined with an additional electrode to form a battery. Alternatively, in some embodiments, the electrode obtained from step 15 can used to form a capacitor (e.g., a supercapacitor).

In some embodiments, the battery may be a lithium-ion rechargeable battery (i.e., secondary battery). In some embodiments, the additional electrode can be a cathode having a different composition than the composite obtained from step 13 or step 14.

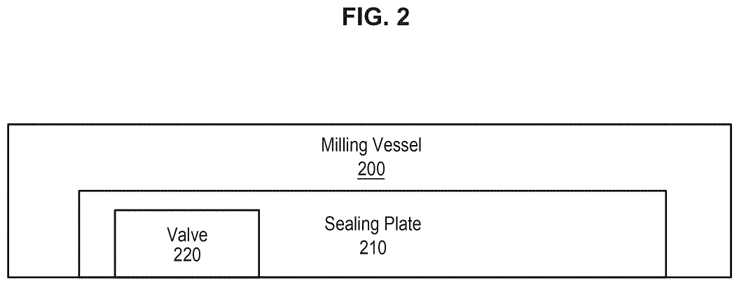

FIG. 2 is a block diagram of a milling vessel 200, according to an embodiment. The milling vessel 200 has an interior volume that includes a sealing plate 210 (e.g., a lid) and a valve 220 disposed on the sealing plate 210. The sealing plate 210 can be mounted onto the milling vessel 200 such that the sealing plate 210 isolates the interior volume from an external environment, thereby creating a sealed interior space.

In some embodiments, the milling vessel 200 can used to perform the method 10 described above in connection with FIG. 1.

The milling vessel 200 can be formed into various sizes depending on the scale of the milling process that is performed with the interior volume. In some embodiments, the interior volume of the milling vessel 200 is at least about 20 cm³, at least about 30 cm³, at least about 40 cm³, at least about 50 cm³, at least about 75 cm³, at least about 100 cm³, at least about 150 cm³, at least about 200 cm³, at least about 250 cm³, at least about 300 cm³, at least about 350 cm³, at least about 400 cm³, at least about 450 cm³, at least about 500 cm³, at least about 750 cm³, at least about 1 L, at least about 5 L, at least about 10 L, at least about 20 L, at least about 30 L, at least about 50 L, at least about 100 L, at least about 200 L, at least about 300 L, at least about 400 L, at least about 500 L, at least about 600 L, at least about 700 L, at least about 800 L, at least about 900 L, at least about 1 m³, at least about 1.5 m³, at least about 2 m³, or at least about 2.5 m³. In some embodiments, the interior volume of the milling vessel 200 is no more than about 3 m³, no more than about 2.5 m³, no more than about 2 m³, no more than about 1.5 m³, no more than about 1 m³, no more than about 900 L, no more than about 800 L, no more than about 700 L, no more than about 600 L, no more than about 500 L, no more than about 400 L, no more than about 300 L, no more than about 200 L, no more than about 100 L, no more than about 50 L, no more than about 25 L, no more than about 10 L, no more than about 1 L, no more than about 500 cm³, or no more than about 250 cm³, no more than about 125 cm³, no more than about 100 cm³, no more than about 75 cm³, no more than about 50 cm³, no more than about 40 cm³, or no more than about 30 cm³. Combinations of the above-referenced volumes are also possible (e.g., at least about 20 cm³ and no more than about 3 m³ or at least about 1 L and no more than about 10 L), inclusive of all values and ranges therebetween.

The milling vessel 200 can be formed into any form factor that can rotate around its axis at some desired speed for a given duration of time. In some embodiments, the milling vessel 200 can have a cylindrical shape. In some embodiments, the milling vessel 200 can have a rectangular prism shape. In some embodiments, the milling vessel 200 can include an eccentric vibrating mill. In some embodiments, the eccentric vibrating mill can include a cylindrical grinding vessel, helical springs, a base frame, grinding media, an exciter unit, and/or a counterweight.

The milling vessel 200 can be formed from at least one of metals or metal alloys. In some embodiments, the milling vessel 200 can be formed from at least one of steel, stainless steel, or titanium.

In some embodiments, the interior volume of the milling vessel 200 can be coated with an insulator. In some embodiments, a cooling system (not shown) can be integrated into the milling vessel 200 such that temperature of the interior volume can be kept substantially steady during a milling process.

In some embodiments, the milling vessel 200 can rotate around its axis at a speed of at least about 300 rpm, at least about 350 rpm, at least about 400 rpm, at least about 450 rpm, at least about 500 rpm, at least about 550 rpm, least about 600 rpm, least about 650 rpm, at least about 700 rpm, at least about 750 rpm, at least about 800 rpm, at least about 850 rpm, at least about 900 rpm, at least about 950 rpm, at least about 1,000 rpm, at least about 1,100 rpm, at least about 1,150 rpm, at least about 1,200 rpm, at least about 1,250 rpm, at least about 1,300 rpm, at least about 1,350 rpm, at least about 1,400 rpm, at least about 1,450 rpm, or at least about 1,500 rpm. In some embodiments, the milling vessel 200 can be configured to be rotated around its axis at a speed of no more than about 2,500 rpm, no more than about 2,400 rpm, no more than about 2,300 rpm, no more than about 2,200 rpm, no more than about 2,100 rpm, no more than about 2,000 rpm, no more than about 1,950 rpm, no more than about 1,900 rpm, no more than about 1,850 rpm, no more than about 1,800 rpm, no more than about 1,750 rpm, no more than about 1,700 rpm, no more than about 1,650 rpm, no more than about 1,600 rpm, no more than about 1,550 rpm, or no more than about 1,500 rpm. Combinations of the above-referenced speeds are also possible (e.g., at least about 300 rpm and no more than about 2,500 rpm or at least about 750 and no more than about 2,000 rpm), inclusive of all values and ranges therebetween.

In some embodiments, the milling vessel 200 can be configured to be rotated around its axis at a speed of about 300 rpm, about 350 rpm, about 400 rpm, about 450 rpm, about 500 rpm, about 550 rpm, least about 600 rpm, least about 650 rpm, about 700 rpm, about 750 rpm, about 800 rpm, about 850 rpm, about 900 rpm, about 950 rpm, about 1,000 rpm, about 1,100 rpm, about 1,150 rpm, about 1,200 rpm, about 1,250 rpm, about 1,300 rpm, about 1,350 rpm, about 1,400 rpm, about 1,450 rpm, or about 1,500 rpm.

In some embodiments, the speed of the rotation of the milling vessel 200 can be adjusted depending on a reaction scale (e.g., amount of the plurality of layered and non-layered particles used in method 10 described in connection with FIG. 1).

The sealing plate 210 can be used to seal the milling vessel 200 such that the interior volume of the milling vessel 210 become isolated from an external environment. The sealing plate 210 can be mounted on the milling vessel 200 by using any type of suitable method. In some embodiments, the sealing plate 210 can be mounted on the milling vessel 200 by using a fastener to couple the sealing plate to the milling vessel 200. In some embodiments, the fastener can include at least one of screws, bolts, nuts, washers, rivets, pins, clips, or anchors.

In some embodiments, the milling vessel 200 can include a sealing member (not shown) for preventing leaks and maintaining pressure. The sealing member that can be disposed between the milling vessel 200 and the sealing plate 210. In some embodiments, the sealing member can include at least one of O-ring seals, gasket seals, mechanical seals, lip seals, or metal seals. The sealing member is configured to prevent the escape of air or fluid, ensuring that the milling vessel 200 remains sealed.

The milling vessel 200 further includes a valve 220 disposed on the sealing plate 210 for controlling the flow of air or fluid into and out of the milling vessel 200. In some embodiments, the valve 220 can be configured to release air or gas present within the milling vessel 200 to an external environment such that pressure of the interior volume of the milling vessel is decreased. In some embodiments, the valve 220 can be configured to decrease pressure within the milling vessel 200 to have a pressure of no more than about 0.3 bar, no more than about 0.2 bar, no more than about 0.1 bar, or no more than about 0.05 bar, within the internal volume.

In some embodiments, the valve 220 can be selected from at least one of Schrader valve, Presta valve, or Dunlop valve. In some embodiments, the valve 220 can include more than one valve.

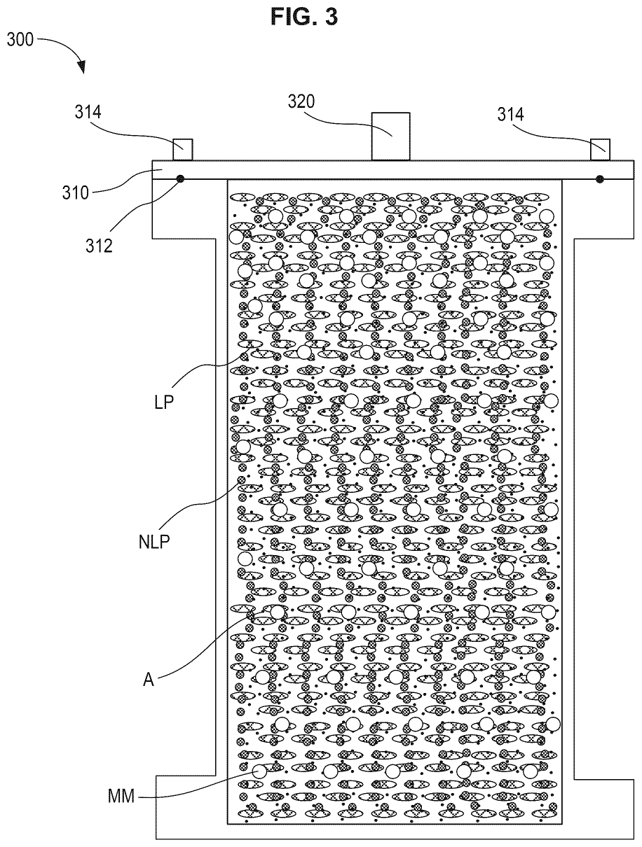

FIG. 3 is an illustration of a milling vessel 300, according to an embodiment. The milling vessel 300 has an interior volume that includes a sealing plate 310 mounted on top of the milling vessel 300 and a valve 320 disposed on the sealing plate 310. The milling vessel 300 further includes a sealing member 312 that is disposed between the milling vessel 300 and the sealing plate 310. In some embodiments, the sealing member 312 can include an O-ring. The milling vessel 300 also includes one or more fasteners 314 to secure the sealing plate 310 on top the milling vessel such that there is no flow of air or fluid into and out of the milling vessel 200. In some embodiments, one or more fasteners may include about 1 fastener, about 2 fasteners, about 3 fasteners, about 4 fasteners, about 5 fasteners, about 6 fasteners, about 7 fasteners, about 8 fasteners, about 9 fasteners, or about 10 fasteners. In some embodiments, the one or more fasteners 314 may include a bolt.

In some embodiments, the milling vessel 300, the sealing plate 310, the valve 320, the sealing member 312 and the fastener 314 can be same or substantially similar to the milling vessel 200, the sealing plate 210, the valve 220, the sealing member, and the fastener described above with respect to FIG. 2.

In some embodiments, the interior volume of the milling vessel 300 can include a plurality of layered particles LP, a plurality of non-layered particles NLP, and a milling media MM. In some embodiments, the interior volume can optionally include an additive A. In some embodiments, at least one of the plurality of layered particles LP, the plurality of non-layered particles NLP, the milling media MM, and/or the additive may be homogenously dispersed within the internal volume. In some embodiments, at least one of the plurality of layered particles LP, the plurality of non-layered particles NLP, the milling media MM, and/or the additive may be heterogeneously dispersed within the internal volume.

In some embodiments, the plurality of layered particles LP, the plurality of non-layered particles NLP, the milling media MM, and the additive A can be same or substantially similar to the plurality of layered particles, the plurality of non-layered particles, the milling media MM, and the additive described above in connection with FIG. 1.

In some embodiments, the milling media MM can make up at least about 20%, at least about 25%, at least about 30%, at least about 35%, at least about 40%, at least about 45%, at least about 50%, at least about 55%, at least about 60%, at least about 65%, or at least about 70%, of the internal volume of the milling vessel 300. In some embodiments, the milling media MM can make up no more than about 95%, no more than about 90%, no more than about 85%, no more than about 80%, no more than about 75%, or no more than about 70% of the internal volume of the milling vessel 300. Combinations of the above-referenced values are also possible (e.g., at least about 20% and no more than about 95% or at least about 20% and no more than about 80%), inclusive of all values and ranges therebetween.

In some embodiments, the amount of the milling media MM can depend on milling process related factors such as but not limited to the running time, the rotational speed, amount/size of the plurality of layered particles LP, the plurality of non-layered particles NLP, the additive A, size of the milling balls, and/or the like.

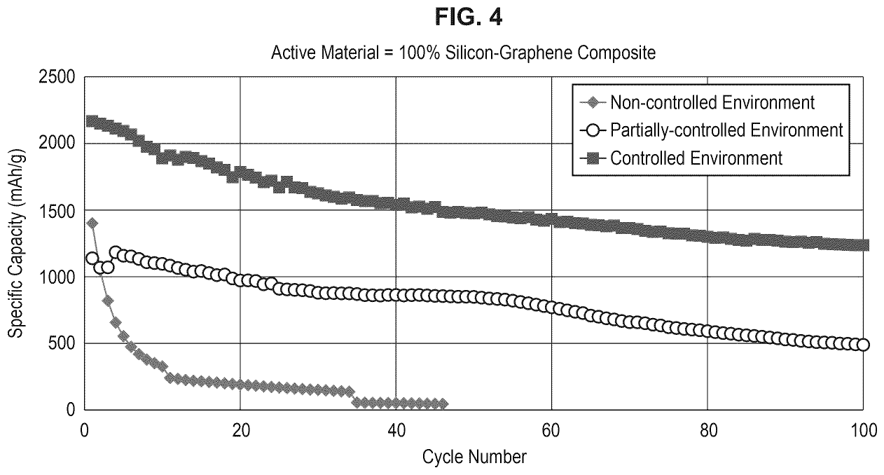

FIG. 4 is a graphical representation of the specific capacity (mAh/g) of electrodes calculated per unit mass of only electrochemically active anode material (i.e., excluding binder and other non-active additives), obtained under various conditions, plotted against the number of cycles. The silicon-graphene composite (i.e., the composite containing silicon and graphene obtained by method 10), produced in a controlled environment, demonstrates a consistently high specific capacity throughout the cycles, indicating superior and long-lasting electrode performance. In contrast, the silicon-graphene composite from a partially controlled environment exhibits a decrease in specific capacity, albeit at a slower pace than the one formed under a non-controlled environment. This indicates that some level of environmental control can improve battery performance. However, the silicon-graphene composite from a non-controlled environment experiences a swift drop in specific capacity, implying a rapid deterioration of battery performance. These findings underscore the critical role of environmental control during the formation of silicon-graphene composites in preserving the performance of batteries. In summary, the silicon-graphene composite obtained in a controlled environment outperforms those from non-controlled and partially controlled environments, maintaining a higher specific capacity over an increasing number of cycles.

### EXAMPLES

Example 1: Silicon microparticles (214 kg), graphite (93 kg), and carbon black (40 kg) were baked at about 157° C. for approximately 4 hours to remove moisture before milling. A titanium cannister loaded with a polymeric milling media (including 50% ¼″ beads, 50% ⅜″ beads) was opened, and filled with the baked materials. The lid was then closed, and secured with six bolts, and vacuum was applied using a Schrader valve on the top surface of the cannister. A vacuum was applied for 2 minutes, or until the vacuum reading was stable at 0.06 bar absolute. The twelve filled cannisters were loaded onto the high-energy cannister mill (HECM), and each cannister was secured using four lug bolts. The mill was run at 53 Hz (760 rpm) for 50 mins. The cannisters were unloaded, and the vacuum pressure was measured to confirm that the vacuum had been retained during milling. The cannisters were subsequently re-filled with air and their lids were removed.

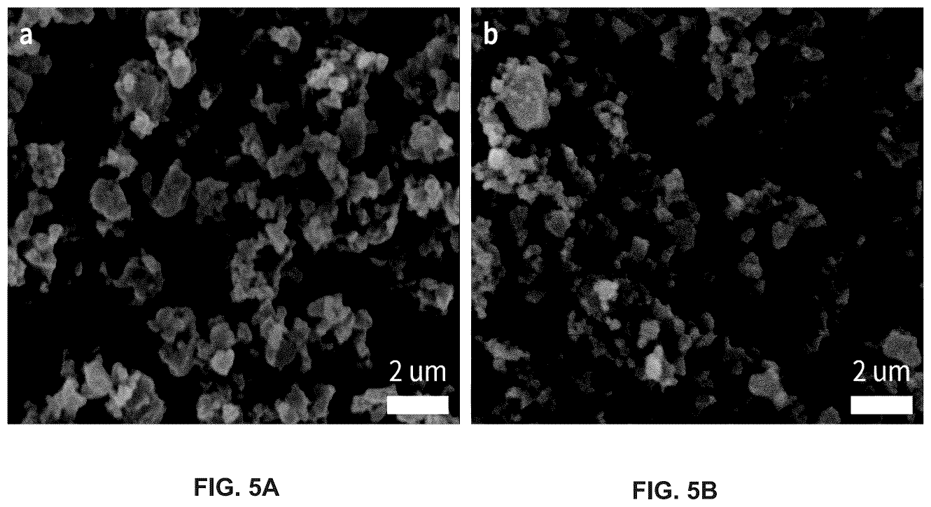

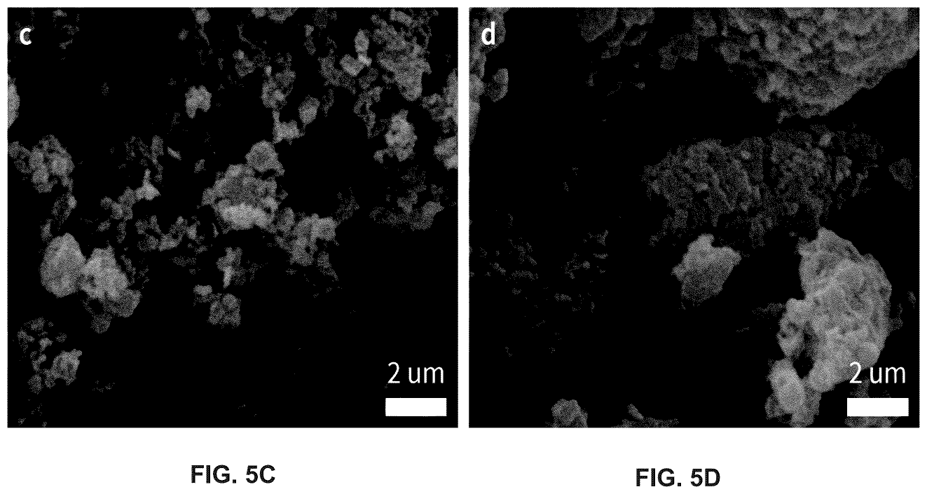

Example 2: A silicon feed material (silicon microparticles), with a particle size (D50) of 1.4 μm, underwent a pre-milling process in a controlled environment (e.g., under vacuum) to refine its particle size. After 100 minutes of milling, the particle size was reduced to a D50 of 0.3 μm. Following the pre-milling step, the silicon particles was then mixed and milled with graphene in a controlled environment to form a silicon-graphene composite, composed of 63% silicon and 37% graphene by weight. The silicon-graphene composite was then blended with pitch in a proportion ranging from 10% to 20% by total weight, mixed for 30 minutes, and then carbonized. Scanning electron microscopy (SEM) images illustrating the material transformations at various processing stages are presented in FIGS. 5A-5D. FIG. 5A shows a SEM image of silicon feed material prior to pre-milling. The image shows the initial morphology of the silicon particles. The surface texture is relatively rough, indicating that the particles have not yet undergone any refinement processes. FIG. 5B shows a SEM image of silicon particles following 100 minutes of pre-milling. The image illustrates the refined particle size, which has been reduced to approximately 0.3 μm. The particles appear more uniform and smaller compared to the initial feed material. FIG. 5C shows a SEM image of the silicon-graphene composite after the milling process. The image shows the silicon particles now coated with graphene. FIG. 5D is a SEM image of the silicon-graphene composite after carbon coating.

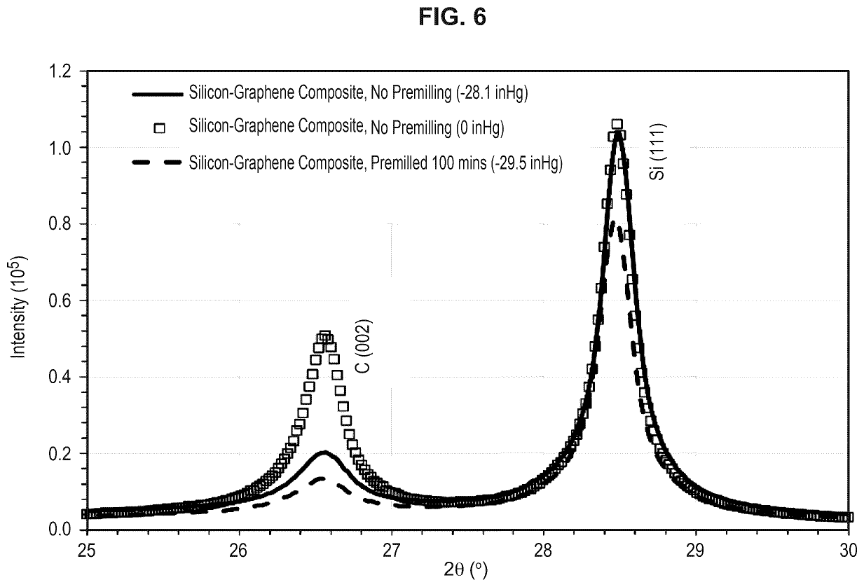

FIG. 6 shows X-ray diffraction (XRD) results comparing the silicon-graphene composite obtained from Example 2 (after the milling step) with silicon-graphene composites formed from Si that did not undergo pre-milling. Additionally, FIG. 6 illustrates the effect of vacuum on the composites during milling. When milling under vacuum (silicon-graphene composite with no pre-milling at −28.1 inHg), the silicon (111) peak is unchanged relative to milling under air (silicon-graphene composite with no pre-milling at 0 inHg), indicating that the atmosphere does not affect the silicon. However, the graphite (002) peak is weaker and broader, indicating a significant decrease in thickness. When Si feed material is pre-milled (silicon-graphene composite pre-milled for 100 minutes at −29.5 inHg), the intensity of the silicon peak is diminished, and the peak slightly broadens, indicating fewer, smaller crystallites (more amorphous).

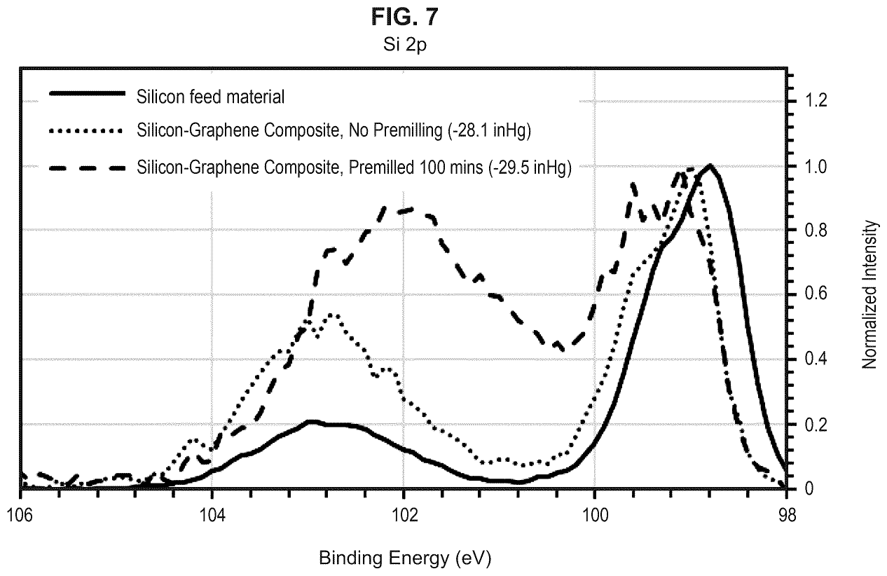

FIG. 7 shows X-ray photoelectron spectroscopy (XPS) results comparing the silicon-graphite composite obtained from Example 2 (after the milling step) with silicon-graphene composites formed from Si that did not undergo pre-milling. After pre-milling and exposure to the atmosphere, there is a significant increase in the number of intermediate silicon oxides [Si(I), Si(II), Si(III), from 100-102 eV in FIG. 7], associated with disordered, partially oxidized silicon and silicon-carbon bonding. When silicon is milled prior to formation of the composite silicon-graphene composite (i.e., when Si is pre-milled) under vacuum, the milling process breaks down the particles and damages the surface layer. This results in the formation of an amorphous, disordered layer on the surface. Once the pre-milled silicon is exposed to air, it gradually oxidizes, leading to a final product that is more oxidized than the original feed material.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items.

Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention.

Additionally, certain of the steps may be performed concurrently in a parallel process when possible, as well as performed sequentially as described above. The embodiments have been particularly shown and described, but it will be understood that various changes in form and details may be made.

### NUMBERED EMBODIMENTS OF THE DISCLOSURE

Notwithstanding the appended claims, the disclosure sets forth the following numbered embodiments:

1. A method, comprising:
mixing a plurality of layered particles with a plurality of non-layered particles;
milling the plurality of layered particles and the plurality of non-layered particles in a controlled environment to form a composite, forming the composite into an electrode.
   2. A method, comprising:
mixing a plurality of layered particles with a plurality of non-layered particles to form a mixture;
milling the plurality of layered particles and the plurality of non-layered particles in a controlled environment, thereby forming a composite, the controlled environment including at least about 99.9 vol % inert gas,
forming the composite into an electrode.
   3. The method of embodiment 1, wherein the controlled environment includes at least about 99.9 vol % inert gas.
   4. The method of any one of embodiments 1-3, wherein the controlled environment has a pressure of no more than about 0.3 bar absolute.
   5. The method of any one of embodiments 1-4, wherein the controlled environment has a pressure of no more than about 0.1 bar absolute.
   6. The method of any one of embodiments 1-5, wherein the controlled environment has a relative humidity of no more than about 0.1%.
   7. The method of any one of embodiments 1-6, wherein the plurality of layered particles include graphite particles.
   8. The method of any one of embodiments 1-7, wherein the plurality of non-layered particles include silicon particles.
   9. The method of embodiment 8, wherein an average particle size (D50) of the silicon particles is between 0.1 μm to 10 μm.
   10. The method of any one of embodiments 1-9, wherein the mixing and the milling occur at least partially simultaneously.
   11. The method of any one of embodiments 1-10, wherein the mixing includes mixing an additive with the plurality of layered particles and the plurality of non-layered particles.
   12. The method of embodiment 11, wherein the additive includes at least one of carbon black, or a plurality of carbon nanotubes.
   13. The method of any one of embodiments 11, and 12, wherein the additive includes LiF.
   14. The method of any one of embodiments 1-13, wherein the composite have a surface area in a range of 60-140 m²/g.
   15. The method of any one of embodiments 1-14, further comprising:
milling the plurality of non-layered particles prior to mixing the plurality of non-layered particles with the plurality of layered particles.
   16. The method of embodiment 15, wherein milling the plurality of non-layered particles is performed in a controlled environment including at least about 99.9 vol % inert gas.
   17. The method of any one of embodiments 15, and 16, wherein milling the plurality of non-layered particles is performed in a controlled environment having a pressure of no more than about 0.3 bar absolute.
   18. The method of any one of embodiments 15-17, wherein milling the plurality of non-layered particles is performed in a controlled environment having a pressure of no more than about 0.1 bar absolute.
   19. The method of any one of embodiments 15-18, wherein milling the plurality of non-layered particles is performed in a controlled environment having a relative humidity of no more than about 0.1%.
   20. The method of any one of embodiments 15-19, wherein milling the plurality of non-layered particles is performed at a speed ranging from about 300 revolutions per minute (rpm) to about 1500 revolutions per minute (rpm).
   21. The method of any one of embodiments 15-20, wherein milling the plurality of non-layered particles is performed for a duration ranging from about 50 minutes to about 200 minutes.
   22. The method of any one of embodiments 15-21, wherein milling the plurality of non-layered particles is configured to reduce an average particle size (D50) of the plurality of non-layered particles by at least about 70%. 23. The method of any one of embodiments 15-22, further comprising:
exposing the plurality of non-layered particles to air after milling the plurality of non-layered particles.
   24. The method of any one of embodiments 15-23, wherein milling the plurality of non-layered particles and milling the plurality of layered particles and the plurality of non-layered particles are performed in a same vessel.
   25. The method of any one of embodiments 1-24, further comprising:
post-treating the composite to obtain a post-treated composite prior to forming the composite into the electrode.
   26. The method of embodiment 25, post-treating the composite comprising:
mixing the composite with a carbon-containing material;
at least partially carbonizing the carbon-containing material to form a carbon layer on a surface of the composite.
   27. The method of embodiment 26, wherein the carbon-containing material includes petroleum pitch.
   28. The method of any one of embodiments 25-27, wherein the post-treated composite have a surface area of less than 25 m2/g.
   29. A composite comprising:
a plurality of non-layered particles; and
a plurality of layered particles disposed on a surface of the plurality of non-layered particles.
   30. The composite of embodiment 29, wherein the composite is produced by the method of any one of embodiments 1-28.
   31. The composite of any one of embodiments 29, and 30, wherein the plurality of layered particles include graphite particles.
   32. The composite of any one of embodiments 29-31, wherein the plurality of non-layered particles include silicon particles.
   33. The composite of embodiment 32, wherein an average particle size (D50) of the silicon particles is between 0.1 μm to 10 μm.
   34. The composite of any one of embodiments 32, and 33, wherein the silicon particles are coated with an oxide layer, the oxide layer including at least one of silicon in +2 oxidation state (Si(II)), silicon in +3 oxidation state (Si(III)), or in +4 oxidation state (Si(IV)).
   35. The composite of any one of embodiments 29-34, wherein the composite have a surface area in a range of 60-140 m²/g.
   36. The composite of any one of embodiments 29-34, wherein the composite further includes a carbon layer, the carbon layer at least partially coating a surface of the composite.
   37. The composite of embodiment 36, wherein the composite have a surface area of less than 25 m²/g.
   38. The composite of any one of embodiment 36, and 37, wherein the composite have a surface area of less than 20 m²/g.
   39. The composite of any one of embodiments 36-38, wherein the composite is in a form of a plurality of particles, and the carbon layer at least partially coats a surface of each composite particle from the plurality of the composite particles.
   40. The composite of embodiment 39, wherein at least three composite particles from the plurality of composite particles are at least partially encapsulated by the carbon layer, forming an agglomerated state.

1. (canceled)

2. A method, comprising:
mixing a plurality of layered particles with a plurality of non-layered particles to form a mixture;
milling the plurality of layered particles and the plurality of non-layered particles in a controlled environment, thereby forming a composite, the controlled environment including at least about 99.9 vol % inert gas,
forming the composite into an electrode.

3. The method of claim 2, wherein the controlled environment includes at least about 99.9 vol % inert gas.

4. The method of 2, wherein the controlled environment has a pressure of no more than about 0.3 bar absolute.

5. The method of 2, wherein the controlled environment has a pressure of no more than about 0.1 bar absolute.

6. The method of 2, wherein the controlled environment has a relative humidity of no more than about 0.1%.

7. The method of 2, wherein the plurality of layered particles include graphite particles.

8. The method of 2, wherein the plurality of non-layered particles include silicon particles.

9. The method of claim 8, wherein an average particle size (D50) of the silicon particles is between 0.1 μm to 10 μm.

10. The method of 2, wherein the mixing and the milling occur at least partially simultaneously.

11. The method of 2, wherein the mixing includes mixing an additive with the plurality of layered particles and the plurality of non-layered particles.

12. The method of claim 11, wherein the additive includes at least one of carbon black, or a plurality of carbon nanotubes.

13. The method of 11, wherein the additive includes LiF.

14. The method of 2, wherein the composite have a surface area in a range of 60-140 m²/g.

15. The method of 2, further comprising:
milling the plurality of non-layered particles prior to mixing the plurality of non-layered particles with the plurality of layered particles.

16. The method of claim 15, wherein milling the plurality of non-layered particles is performed in a controlled environment including at least about 99.9 vol % inert gas.

17. The method of 15, wherein milling the plurality of non-layered particles is performed in a controlled environment having a pressure of no more than about 0.3 bar absolute.

18. The method of 15, wherein milling the plurality of non-layered particles is performed in a controlled environment having a pressure of no more than about 0.1 bar absolute.

19. The method of 15, wherein milling the plurality of non-layered particles is performed in a controlled environment having a relative humidity of no more than about 0.1%.

20. The method of 15, wherein milling the plurality of non-layered particles is performed at a speed ranging from about 300 revolutions per minute (rpm) to about 1500 revolutions per minute (rpm).

21. The method of 15, wherein milling the plurality of non-layered particles is performed for a duration ranging from about 50 minutes to about 200 minutes.

22. The method of 15, wherein milling the plurality of non-layered particles is configured to reduce an average particle size (D50) of the plurality of non-layered particles by at least about 70%.

23. The method of 15, further comprising:
exposing the plurality of non-layered particles to air after milling the plurality of non-layered particles.

24. The method of 15, wherein milling the plurality of non-layered particles and milling the plurality of layered particles and the plurality of non-layered particles are performed in a same vessel.

25. The method of 2, further comprising:
post-treating the composite to obtain a post-treated composite prior to forming the composite into the electrode.

26. The method of claim 25, post-treating the composite comprising:
mixing the composite with a carbon-containing material;
at least partially carbonizing the carbon-containing material to form a carbon layer on a surface of the composite.

27. The method of claim 26, wherein the carbon-containing material includes petroleum pitch.

28. The method of 25, wherein the post-treated composite have a surface area of less than 25 m²/g.

29-40. (canceled)
